(19) United States
(12) Patent Application Publication
(10) Pub. No.: US 2026/0367590 A1
(43) Pub. Date: Nov. 19, 2026

(54) SYSTEMS, APPARATUSES, METHODS, AND COMPUTER PROGRAM PRODUCTS FOR CO-CONTROL FOR PLANTWIDE OPTIMIZATION

(71) Applicant: Honeywell International Inc., Charlotte, NC (US)

(72) Inventor: Joseph Lu, Glendale, AZ (US)

(21) Appl. No.: 19/210,660

(22) Filed: May 16, 2025

(51) Int. Cl. G05B 13/04

(52) U.S. Cl. CPC G05B 13/041; G05B 13/048

(57) ABSTRACT

Systems, apparatuses, methods, and computer program products are provided herein. For example, a method may include determining a set of secondary controller CV constraints. The set of secondary controller CV constraints may include one or more constraints associated with a first secondary controller CV that satisfies a set of co-control criteria. The method may further include establishing a set of co-control bounds for the set of secondary controller CV constraints based on a set of non-conjoint MVs and a tuning parameter. The method may further include dynamically augmenting a master controller model with the set of secondary controller CV constraints and the set of co-control bounds to generate an augmented master controller model. The method may further include enabling the master controller to perform one or more optimization iterations based on the augmented master controller model.

### TECHNOLOGICAL FIELD

Embodiments of the present disclosure relate generally to plantwide optimization; and particularly to systems, apparatuses, methods, and computer program products for co-control for plantwide optimization.

### BACKGROUND

Various embodiments of the present disclosure address technical challenges related to systems, apparatuses, methods, and computer program products for optimizing a plant. Through applied effort, ingenuity, and innovation many deficiencies of existing techniques and plantwide optimization systems have been solved by developing solutions that are in accordance with the embodiments as discussed herein, many examples of which are described in detail herein.

### BRIEF SUMMARY

Various embodiments described herein relate to systems, apparatuses, methods, and computer program products for co-control for plantwide optimization.

In accordance with one aspect of the present disclosure, a computer-implemented method for co-control for plantwide optimization is provided. In some embodiments, the computer-implemented method comprises determining, based on a set of co-control criteria, a set of secondary controller controlled variable (CV) constraints, wherein the set of secondary controller CV constraints comprises one or more constraints associated with a first secondary controller CV that satisfies the set of co-control criteria, and wherein the set of secondary controller CV constraints is associated with a set of control bounds; establishing a set of co-control bounds for the set of secondary controller CV constraints based on (i) a set of non-conjoint manipulated variables associated with the first secondary controller CV and (ii) a tuning parameter; dynamically augmenting a master controller model associated with a master controller with the set of secondary controller CV constraints and the set of co-control bounds to generate an augmented master controller model; and enabling the master controller to perform one or more optimization iterations based on the augmented master controller model. In some embodiments, the set of secondary controller CV constraints corresponds to a set of conjoint secondary controller manipulated variables (MVs) associated with the first secondary controller CV. In some embodiments, a first secondary controller MV of the set of conjoint secondary controller MVs is a conjoint MV with a first master controller MV of a set of master controller MVs associated with the master controller, and wherein a second secondary controller MV of the set of conjoint secondary controller MVs is a conjoint MV with a second master controller MV of the set of master controller MVs associated with the master controller. In some embodiments, determining the set of secondary controller CV constraints comprises determining the set of secondary controller CV constraints satisfy at least one co-control criteria from the set of co-control criteria. In some embodiments, the set of co-control criteria comprises one or more of: (i) a secondary controller CV constraint predicted to be violated by a current predicted optimal operating point, (ii) a secondary controller CV constraint predicted to be within a threshold distance from a set of control bounds associated with the secondary controller CV constraint within a predefined tolerance; or (iii) a secondary controller CV constraint that currently violates a set of control limits for the secondary controller CV constraint. In some embodiments, the first secondary controller CV is associated with a feasible operating region defined at least in part by the set of secondary controller CV constraints, wherein an optimal operating point is within the feasible operating region. In some embodiments, the feasible operating region is further defined at least in part by another set of secondary controller CV constraints associated with a second secondary controller CV, wherein the first secondary controller CV and the second secondary controller CV are associated with same secondary controller model, wherein the augmented master controller model further comprises the another set of secondary controller CV constraints. In some embodiments, enabling the master controller to perform the one or more optimization iterations causes a reduction in distance between (i) a current predicted operating point and (ii) the optimal operating point. In some embodiments, a first optimization iteration of the one or more optimization iterations causes a current predicted optimal operating point to be within the feasible operating region. In some embodiments, a second optimization iteration of the one or more optimization iterations causes the current predicted optimal operating point to move towards the optimal operating point. In some embodiments, the tuning parameter is configurable and is between a range of 0 to 1. In some embodiments, establishing the set of co-control bounds for the set of secondary controller CV constraints based on the set of non-conjoint MVs is configured to cause the set of control bounds of the set of secondary controller CV constraints to be relaxed within the master controller. In some embodiments, the computer-implemented method further comprises detecting conflict between the first secondary controller CV and a master controller CV associated with the master controller; and resolving the conflict by one or more of (i) increasing the tuning parameter or (ii) increasing a weight associated with the first secondary controller CV. In some embodiments, the computer-implemented method further comprises detecting conflict between the first secondary controller CV and a master controller CV associated with the master controller; and resolving the conflict by one or more of (i) decreasing the tuning parameter or (ii) decreasing a weight associated with the first secondary controller CV. In some embodiments, the computer-implemented method further comprises transmitting one or more computer-executable instructions configured to cause rendering of a user interface on a client computing device, wherein the user interface comprises data associated with the first secondary controller CVs.

In accordance with another aspect of the present disclosure, an apparatus is provided. The apparatus in some embodiments includes at least one processor and at least one non-transitory memory, the at least one non-transitory memory having computer-coded instructions stored thereon. The computer-coded instructions in execution with the at least one processor causes the apparatus to perform any of the example computer-implemented methods described herein. In some other embodiments, the apparatus includes means for performing each step of any of the computer-implemented methods described herein.

In accordance with another aspect of the present disclosure, a computer program product is provided. The computer program product in some embodiments includes at least one non-transitory computer-readable storage medium having computer program code stored thereon. The computer program code in execution with at least one processor is configured for performing any one or the example computer-implemented methods described herein.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE DRAWINGS

Having thus described the embodiments of the disclosure in general terms, reference now will be made to the accompanying drawings, which are not necessarily drawn to scale, and wherein:

FIG. 1 illustrates an exemplary block diagram of an environment in which embodiments of the present disclosure may operate.

FIG. 2 illustrates an exemplary block diagram of an example apparatus that may be specially configured in accordance with an example embodiment of the present disclosure.

FIG. 3A illustrates an example representation of a master controller model in accordance with one or more embodiments of the present disclosure.

FIG. 3B illustrates an example representation of a secondary controller model in accordance with one or more embodiments of the present disclosure.

FIG. 3C illustrates an example master controller model matrix and secondary controller model matrix in accordance with one or more embodiments of the present disclosure.

FIG. 4 illustrates an example master controller MV space in accordance with one or more embodiments of the present disclosure.

FIG. 5 illustrates example visualization of secondary controller CV constraint representation within a master controller model in accordance with one or more embodiments of the present disclosure.

FIG. 6 illustrates a flowchart of an example method in accordance with one or more embodiments of the present disclosure.

### DETAILED DESCRIPTION

Embodiments of the present disclosure now will be described more fully hereinafter with reference to the accompanying drawings, in which some, but not all, embodiments of the disclosure are shown. Indeed, embodiments of the present disclosure may be embodied in many different forms and should not be construed as limited to the embodiments set forth herein, rather, these embodiments are provided so that this disclosure will satisfy applicable legal requirements. The term “or” is used herein in both the alternative and conjunctive sense, unless otherwise indicated.

The terms “illustrative” and “example” are used to be examples with no indication of quality level. Terms such as “computing,” “determining,” “generating,” and/or similar words are used herein interchangeably to refer to the creation, modification, or identification of data. Further, “based on,” “based on in part on,” “based at least on,” “based upon,” and/or similar words are used herein interchangeably in an open-ended manner such that they do not indicate being based only on or based solely on the referenced element or elements unless so indicated. Like numbers refer to like elements throughout.

It should be understood at the outset that although illustrative implementations of one or more aspects are illustrated below, the disclosed systems, apparatuses, methods, and computer program products may be implemented using any number of techniques, whether currently known or not yet in existence. The disclosure should in no way be limited to the illustrative implementations, drawings, and techniques illustrated below, but may be modified within the scope of the appended claims along with their full scope of equivalents. While values for dimensions of various elements may be disclosed, the drawings may not be to scale.

### Overview and Technical Improvements

Example embodiments disclosed herein address technical problems associated with systems, apparatuses, methods, and computer program products for optimizing a plant. As would be understood by one skilled in the field to which this disclosure pertains, there are numerous example scenarios in which systems, apparatuses, methods, and computer program products for optimizing a plant are desirable.

In many applications it may be desirable to use systems, apparatuses, methods, and computer program products for optimizing a plant. For example, it may be desirable to use systems, apparatuses, methods, and computer program products for optimizing a plant to improve the efficiency of the plant. As another example, it may be desirable to use systems, apparatuses, methods, and computer program products for optimizing a plant to control the emissions of the plant. As another example, it may be desirable to use systems, apparatuses, methods, and computer program products for optimizing a plant to control how much processed product the plant produces. As another example, it may be desirable to use systems, apparatuses, methods, and computer program products for optimizing a plant to control when a plant makes particular processed products instead of other processed products. As another example, it may be desirable to use systems, apparatuses, methods, and computer program products for optimizing a plant to control what particular processed products a plant makes instead of other processed products. As another example, it may be desirable to use systems, apparatuses, methods, and computer program products for optimizing a plant to manage maintenance actions associated with the plant.

Example systems for optimizing a plant include using a computing device to control the operations of the plant. Processing facilities/plants may be managed using industrial process control and automation systems. Such control and automation systems may include multiple hierarchical layers that perform different functions. For example, lower layers may include devices that perform process control functions and model predictive control (MPC) operations, while higher layers may include devices that provide plantwide optimization solutions. In some applications, a plant wide controller may be used to control the master CVs (e.g., PWO primary CVs), while secondary controllers (e.g., secondary MPCs) control their respective CVs. Manipulatable variable linkage between the PWO layer and the secondary MPC layer may be used for optimization, with the PWO controller performing optimization operations to guide the secondary MPCs towards a globally optimal operating point.

However, such example systems are technically deficient and reactive. For example, such example systems are technically deficient because such example systems are unable to implement a framework for casting secondary controller feasible space into a PWO CMV space in certain scenarios, including those where the secondary controller feasible space forms a slanted belt such that adjusting the proxy limit search bandwidth (e.g., whether increasing or decreasing) may not suffice to resolve the issue. Moreover, the PWO may be restricted within a small proxy region, hence the resulting optimal solution may be far away from the true optimal solution Further, it may take many iterations to move toward the true optimal without violating constraints associated with the secondary controllers. In this regard, a need exists for co-control (dual control) for PWO optimization, as described herein using both the conjoint MVs of PWO and other non-conjoint MVs in the secondary controller. For example, in many applications, it is desirable to control the PWO's primary CVs together with selected secondary controller CVs. However, in MPC cascade designs, the PWO controller's model is generally separated from the secondary MPC's model.

Thus, to address the above issues and/or other issues, example systems, apparatuses, methods, and computer program products for co-control for plantwide optimization are disclosed herein. For example, an embodiment in this disclosure, described in greater detail below, includes a method that determines based on a set of co-control criteria, a set of secondary controller CV constraints. In some embodiments, the set of secondary controller CV constraints comprises one or more constraints associated with a first secondary controller CV that satisfies the set of co-control criteria. In some embodiments, the set of secondary controller CV constraints is associated with a set of control bounds. In some embodiments, the method comprises establishing a set of co-control bounds for the set of secondary controller CV constraints based on (i) a set of non-conjoint MVs associated with the first secondary controller CV and (ii) a tuning parameter; dynamically augmenting a master controller model associated with a master controller with the set of secondary controller CV constraints and the set of co-control bounds to generate an augmented master controller model; and enabling the master controller to perform one or more optimization iterations based on the augmented master controller model.

Accordingly, the systems, apparatuses, methods, and computer program products provided herein are able effectively optimize a plant in a technically sufficient and proactive manner.

### DEFINITIONS

Many modifications and other embodiments of the disclosure set forth herein will come to mind to one skilled in the art to which this disclosure pertains having the benefit of the teachings presented in the foregoing description and the associated drawings. Therefore, it is to be understood that the embodiments are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

As used herein, the term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of.

The phrases “in one embodiment,” “according to one embodiment,” “in some embodiments,” and the like generally mean that the particular feature, structure, or characteristic following the phrase may be included in at least one embodiment of the present disclosure, and may be included in more than one embodiment of the present disclosure (importantly, such phrases do not necessarily refer to the same embodiment).

The word “example” or “exemplary” is used herein to mean “serving as an example, instance, or illustration.” Any implementation described herein as “exemplary” is not necessarily to be construed as preferred or advantageous over other implementations.

If the specification states a component or feature “may,” “can,” “could,” “should,” “would,” “preferably,” “possibly,” “typically,” “optionally,” “for example,” “often,” or “might” (or other such language) be included or have a characteristic, that a specific component or feature is not required to be included or to have the characteristic. Such a component or feature may be optionally included in some embodiments, or it may be excluded.

As used herein, the terms “data,” “content,” “information,” and similar terms may be used interchangeably to refer to data capable of being transmitted, received, or stored in accordance with embodiments of the present disclosure. Thus, use of any such terms should not be taken to limit the spirit and scope of embodiments of the present disclosure. Further, where a computing device is described herein to receive data from another computing device, it will be appreciated that the data may be received directly from another computing device or may be received indirectly via one or more intermediary computing devices, such as, for example, one or more servers, relays, routers, network access points, base stations, hosts, or the like, sometimes referred to herein as a “network.” Similarly, where a computing device is described herein to send data to another computing device, it will be appreciated that the data may be sent directly to another computing device or may be sent indirectly via one or more intermediary computing devices, such as, for example, one or more servers, relays, routers, network access points, base stations, hosts, or the like.

As used herein, the term “circuitry” refers to particular hardware configured to perform the functions associated with the particular circuitry as described herein. In some embodiments, circuitry may be used as part of (a) hardware-only circuit implementations (e.g., implementations in analog circuitry or digital circuitry); (b) combinations of circuits and computer program product(s) comprising software or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. In some embodiments, “circuitry” may include processing circuitry, storage media, network interfaces, input/output devices, or the like. As a further example, as used herein, the term “circuitry” also includes an implementation comprising one or more processors or portion(s) thereof and accompanying software or firmware. As another example, the term “circuitry” as used herein also includes, for example, a baseband integrated circuit or applications processor integrated circuit for a mobile phone or a similar integrated circuit in a server, a cellular network device, other network device, or other computing device.

As used herein, a “computer-readable storage medium,” refers to a physical storage medium (e.g., volatile, or non-volatile memory device), and may be differentiated from a “computer-readable transmission medium,” which refers to an electromagnetic signal. A computer-readable storage medium may be a non-transitory medium.

As used herein, the terms “data structure,” “data object,” or “data set” refer interchangeably to data capable of being transmitted, received, or stored. For example, a predicted asset may be associated with one or more data elements or values in a computer-readable storage medium or computer-readable transmission medium, that represents content that is configured for use or display by one or more software applications, services, microservices, or the like.

As used herein, the terms “application,” “software application,” “app,” “computer program,” “service,” or similar terms refer to a computer program or group of computer programs designed to perform coordinated functions, tasks, or activities. Such computer programs may be operated by or for the benefit of a user or group of users. An application may be configured to provide access to one or more services provided by an entity. For example, an application may be configured to provide access to services provided by visual media content provider systems. An application may run on a server or group of servers, such as, but not limited to, web servers and application servers. In some embodiments, an application may be run on or across one or more other computing devices (e.g., user devices). For example, an application may be configured to be accessed via a web browser (e.g., a website accessed via the Internet using a browser), a dedicated client running on a user device, or the like. In some examples, an application may be configured for use by and interaction with one or more local, networked or remote computing devices.

The term “client computing device,” “client device” “client computing entity” and similar terms may be used interchangeably to refer to a computer comprising at least one processor and at least one memory. In some embodiments, the client computing device may further comprise one or more of: a display device for rendering one or more of a graphical user interface, a vibration motor for a haptic output, a speaker for an audible output, a mouse, a keyboard or touch screen, a global position system (GPS) transmitter and receiver, a radio transmitter and receiver, a microphone, a camera, a biometric scanner (e.g., a fingerprint scanner, an eye scanner, a facial scanner, etc.), or the like. Additionally, the term “client computing device” and the aforementioned similar terminology may refer to computer hardware or software that is configured to access a service or functionality offered by a system, for example, a service or functionality that is made available by a server. Such a server may be in a different location or another computing system, in which case the client computing device may access the server by way of a network. Client computing devices may include, without limitation, smart phones, tablet computers, kiosk, terminal, laptop computers, wearables, personal computers, enterprise computers, or the like. Client computing devices, as described herein, may communicate with or otherwise access a computing system, via one or more networks. In some embodiments, the at least one processor and the at least one memory need not be physically co-located with other elements of the client computing device (e.g., in a terminal environment, in which a display may be separated from a server-based processor or memory).

In some embodiments, a client computing device may be associated with a particular operator. In some embodiments, a client computing device may be a general purpose computing device having special purpose computer programming stored or executed thereon (e.g., a program, application, or web browser session running on a personal computer or smartphone). In some embodiments, a client computing device may be configured as a terminal or other remote viewing apparatus configured to display graphical user interfaces and associated information generated on a remote computing device. In some embodiments, a client computing device may be a special purpose computing device configured to perform the various functions described herein. Various embodiments of client computing devices may include, without limitation, smartphones, tablets, laptops, terminals, kiosks, personal computers, desktop computers, enterprise computers, or the like. Various embodiments of client computing devices may operate using different operating systems including, without limitation, IOS, ANDROID, WINDOWS, MACOS, LINUX, CHROME OS, or the like.

As used herein, the term “graphical user interface” refers to a representation of a software interface. For example, a graphical user interface may be the visual representation of a software such as a website, mobile application, desktop application, or the like, that may be used to generally interface with the software. By way of example, images, buttons, links, backgrounds, text fields, or the like, may be included within or make up a graphical user interface. In various examples, a graphical user interface may be configured for display on one or more screens (e.g., a screen of a mobile phone, a personal computer, or the like).

As used herein, the term “application programming interface” and “API” refers to a computing interface that defines indication inputs between applications, services, microservices, computing devices, repositories, or the like. An API may define formatting for one or more of a programming code call, request, function, procedure, notification, data object, data structure, or the like. Non-limiting examples of an application programming interface may include JavaScript Object Notation (JSON), Extensible Markup Language (XML), Simple Object Access Protocol (SOAP), Hypertext Markup Language (HTML), the like, or combinations thereof.

As used herein, the term “repository,” “database,” and similar terms may be used interchangeably to refer to a computing location associated with a system where data is stored, accessed, modified, and otherwise maintained by the system. A repository may be used to store data in association with a data storage protocol or a query language. In certain embodiments, a repository may embody a data storage device or devices, a separate database server or servers, or as a combination of data storage devices and separate database servers. Further, in some embodiments, a repository may be embodied as a distributed repository such that some of the stored data is stored centrally in a location within the repository and other data stored in a single remote location or a plurality of remote locations. Alternatively, in some embodiments, a repository may be distributed over a plurality of remote storage locations only such as in a cloud storage environment.

As used herein, the term “machine learning model” refers to one or more processes, algorithms, or other data entity that describes parameters, hyper-parameters, defined operations, or defined mappings of a model that is configured to process one or more inputs in accordance with one or more trained parameters of the machine learning models in order to generate a prediction. An example of a machine learning model is a mathematically derived algorithm (MDA). An MDA may comprise any algorithm trained using training data to predict one or more outcome variables. Without limitation, an MDA, as used herein, may comprise machine learning frameworks including neural networks, deep neural networks, generative adversarial networks, convolutional neural networks, recurrent neural networks, large language models, generative pre-trained transformers (GPT), support vector machines, gradient boosts, decision trees, random forests, Markov models, adaptive Bayesian techniques, and statistical models (e.g., timeseries-based forecast models such as autoregressive models, autoregressive moving average models, or an autoregressive integrating moving average models). Additionally, and without limitation, an MDA, as used in the singular, may include ensembles using multiple machine learning or statistical techniques.

### Example Systems and Apparatuses

Various embodiments of the present disclosure may be implemented as methods, apparatus, systems, computing devices, computer program products, or the like. As such, embodiments of the present disclosure may take the form of an apparatus, system, computing device, computing entity, or the like executing instructions stored on a computer-readable storage medium to perform certain steps or operations. Thus, embodiments of the present disclosure may take the form of an entirely hardware embodiment, an entirely computer program product embodiment, or an embodiment that comprises a combination of computer program products and hardware performing certain steps or operations.

Embodiments of the present disclosure are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, or apparatus, systems, computing devices, computing devices, or the like carrying out instructions, operations, steps, and similar words used interchangeably (e.g., the executable instructions, instructions for execution, program code, or the like) on a computer-readable storage medium for execution. For example, retrieval, loading, and execution of code may be performed sequentially such that one instruction is retrieved, loaded, and executed at a time. In some example embodiments, retrieval, loading, or execution may be performed in parallel such that multiple instructions are retrieved, loaded, or executed together. Thus, such embodiments may produce specifically configured machines performing the steps or operations specified in the block diagrams and flowchart illustrations. Accordingly, the block diagrams and flowchart illustrations support various combinations of embodiments for performing the specified instructions, operations, or steps.

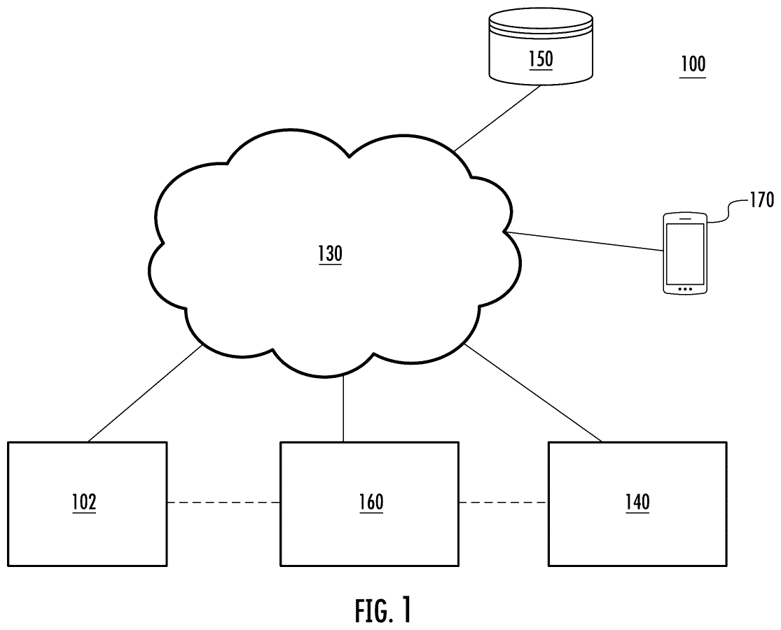

In this regard, FIG. 1 shows an example system environment 100 (e.g., industrial process control and automation system environment 100) within which at least some embodiments of the present disclosure may operate. The depiction of the example system environment 100 is not intended to limit or otherwise confine the embodiments described and contemplated herein to any particular configuration of elements or systems, nor is it intended to exclude any alternative configurations or systems for the set of configurations and systems that can be used in connection with embodiments of the present disclosure. Rather, FIG. 1 and the system environment 100 disclosed therein is merely presented to provide an example basis and context for the facilitation of some of the features, aspects, and uses of the methods, apparatuses, computer readable media, and computer program products disclosed and contemplated herein.

The system environment includes a plant 102. In some embodiments, for example, the plant 102 may be any type of plant associated with the environment 100. In this regard, the plant 102 may, for example, be a processing plant that receives and processes input ingredients to create a processed product, such as a hydrocarbon processing plant, a refinery, a pulp and paper plant, a chemical plant, an alumina plant, a drilling facility, a fracking field, and/or the like.

The plant 102 in some embodiments includes any number of individual physical processing units. The physical processing units of the plant 102 may perform a particular function during operation of the plant 102. For example, the physical processing units may include one or more well physical processing units, fracking physical processing units, crude processing physical processing units (e.g., crude processing physical processing units having a vacuum section), hydrotreating physical processing units, isomerization physical processing units, reforming physical processing units, vapor recovery physical processing units, fluid catalytic cracking physical processing units, batch blending physical processing units, rundown blending physical processing units, hydrocracking physical processing units, alkylation physical processing units, dewaxing physical processing units, deasphalter physical processing units (e.g., propane deasphalter physical processing units), aromatics reduction physical processing units, delayed cooker physical processing units, visbreaker physical processing units, digester physical processing units, thermomechanical grinding physical processing units, bleaching physical processing units, blender physical processing units, pump physical processing units, flash venting physical processing units, compressor physical processing units, cooler physical processing units (e.g., air cooler physical processing units), sensor physical processing units, flare physical processing units, heating, ventilation, and air (HVAC) physical processing units, lighting physical processing units, and/or the like that perform a particular operation for transforming, separating, reacting, reforming, digesting, bleaching, storing, releasing, and/or otherwise handling one or more input ingredients, intermediate ingredients, and/or processed products (e.g., hydrocarbons, gases, etc.). In this regard, for example, the individual physical processing units of the plant 102 may include physical processing units associated with a particular process performed by the plant 102.

The plant 102 in some embodiments includes any number of individual physical streams. The physical streams of the plant 102 may perform a particular function during operation of the plant 102. For example, the physical streams may include one or more liquefied petroleum gas physical streams, straight-run gasoline physical streams, naphtha physical streams, middle distillates physical streams, crude physical streams, heavy atmospheric gasoil physical streams, vacuum gasoil physical streams, lube base stocks physical streams, fuel gas physical streams, light gasoil physical streams, gasoline physical streams, fractionator bottoms physical streams, fuel oil physical streams, asphalt physical streams, refinery fuel physical streams, regular gasoline physical streams, solvents physical streams, aviation fuel physical streams, diesel physical streams, heating oil physical streams, lube oil physical streams, grease physical streams, industrial fuel physical streams, wood chip physical streams, brown stock physical streams, white liquor physical streams, bleached pulp physical streams, and/or the like that perform a particular operation for transforming, storing, releasing, transporting, and/or otherwise handling one or more input ingredients, intermediate ingredients, and/or processed products (e.g., hydrocarbons, gases, etc.). In this regard, for example, the individual physical streams of the plant 102 may include physical streams associated with a particular process performed by the plant 102.

The plant 102 in some embodiments includes any number of individual physical storage units. The physical storage units may perform a particular function during operation of the plant 102. For example, the physical storage units may include one or more input physical storage units, intermediate physical storage units, component physical storage units, processed product physical storage units, and/or the like that perform a particular operation for transforming, storing, releasing, transporting, and/or otherwise handling one or more input ingredients, intermediate ingredients, and/or processed products (e.g., hydrocarbons, gases, etc.). In this regard, for example, the individual physical streams of the plant 102 may include physical storage units associated with a particular process performed by the plant 102.

In some embodiments, each individual physical processing unit, each individual physical storage unit, and/or each individual physical stream of the plant 102 is associated with a determinable location. The determinable location of a particular physical processing unit, physical storage unit, and/or physical stream in some embodiments represents an absolute position (e.g., GPS coordinates, latitude, and longitude locations, and/or the like) or a relative position (e.g., a point representation of the location of a physical processing unit, physical storage unit, and/or physical stream from a local origin point corresponding to the plant 102). In some embodiments, a physical processing unit, physical storage unit, and/or physical stream includes or otherwise is associated with a location sensor and/or software-driven location services that provide the location data representing the location corresponding to that physical processing unit, physical storage unit, and/or physical stream. In other embodiments the location of a physical processing unit, physical storage unit, and/or physical stream is stored and/or otherwise predetermined within a software environment, provided by a user and/or otherwise determinable to one or more systems.

Additionally, or alternatively, in some embodiments, the plant 102 itself is associated with a determinable location. The determinable location of the plant 102 in some embodiments represents an absolute position (e.g., GPS coordinates, latitude and longitude locations, an address, and/or the like) or a relative position of the plant 102 (e.g., an identifier representing the location of the plant 102 as compared to one or more other plants, one or more other buildings, an enterprise headquarters, or general description in the world for example based at least in part on continent, state, or other definable region). In some embodiments, the plant 102 includes or otherwise is associated with a location sensor and/or software-driven location services that provide the location data corresponding to the plant 102. In other embodiments, the location of the plant 102 is stored and/or otherwise determinable to one or more systems.

The network 130 may be embodied in any of a myriad of network configurations. In some embodiments, the network 130 may be a public network (e.g., the Internet). In some embodiments, the network 130 may be a private network (e.g., an internal localized, or closed-off network between particular devices). In some other embodiments, the network 130 may be a hybrid network (e.g., a network enabling internal communications between particular connected devices and external communications with other devices). In various embodiments, the network 130 may include one or more base station(s), relay(s), router(s), switch(es), cell tower(s), communications cable(s), routing station(s), and/or the like. In various embodiments, components of the environment 100 may be communicatively coupled to transmit data to and/or receive data from one another over the network 130. Such configuration(s) include, without limitation, a wired or wireless Personal Area Network (PAN), Local Area Network (LAN), Metropolitan Area Network (MAN), Wide Area Network (WAN), and/or the like.

In some embodiments, the environment 100 may include a master controller 140 (e.g., MPC controller). In some embodiments, for example, the master controller 140 may be configured to optimize one or more plants (e.g., plant 102), such as by performing an optimization operation. In this regard, for example, the master controller 140 may be configured to optimize operations of the plant 102. The master controller 140 may be electronically and/or communicatively coupled to the plant 102, individual physical processing units of the plant 102, individual physical storage units of the plant 102, individual physical streams of the plant 102, one or more databases 150, one or more secondary controllers 160 (e.g., slave MPC controller(s) 160), and/or one or more user devices 170. The master controller 140 may be located remotely, in proximity of, and/or within the plant 102. In some embodiments, the master controller 140 is configured via hardware, software, firmware, and/or a combination thereof, to perform data intake of one or more types of data associated with one or more of the plant 102, individual physical processing units of the plant 102, individual physical storage units of the plant 102, individual physical streams of the plant 102, one or more databases 150, the secondary controller 160, and/or one or more user devices 170. Additionally, or alternatively, in some embodiments, the master controller 140 is configured via hardware, software, firmware, and/or a combination thereof, to generate and/or transmit command(s) that control, adjust, or otherwise impact operations of plant 102, individual physical processing units of the plant 102, individual physical storage units of the plant 102, individual physical streams of the plant 102, one or more databases 150, the secondary controller 160, and/or one or more user devices 170, for example for controlling one or more operations of the plant 102. Additionally, or alternatively still, in some embodiments, the master controller 140 is configured via hardware, software, firmware, and/or a combination thereof, to perform data reporting and/or other data output process(es) associated with monitoring or otherwise analyzing operations of plant 102, individual physical processing units of the plant 102, individual physical storage units of the plant 102, individual physical streams of the plant 102, one or more databases 150, the secondary controller 160, and/or one or more user devices 170, for example for generating and/or outputting report(s) corresponding to the operations performed via the plant 102. For example, in various embodiments, the master controller 140 may be configured to execute and/or perform one or more operations and/or functions described herein. In some embodiments, the master controller 140 leverages a coarse-scale model, such as a flow sheet model, planning model, and/or other suitable reduced model(s) to facilitate performance of one or more functions of the master controller 140. For example, the master controller 140 may use a flow sheet model/planning model (e.g., a yield-based single period model or the like) to provide an initial steady-state gain matrix, and relevant model dynamics may be determined using operational data of the plant 102. In some embodiments, the master controller 140 may use the flow sheet model/planning model to provide a dynamic gain matrix. In some example implementations, the master controller 140 may operate to control product inventories, manufacturing activities, and/or product qualities within the plant 102. For example, in some embodiments, the master controller 140 may be configured to perform plantwide optimization (e.g., using an embedded optimizer thereof) to control production inventories, manufacturing activities, or product qualities inside the plant 102. By way of example, the embedded optimizer of the master controller 140, may provide offline planning optimization but in an online and real-time manner. The optimizer may execute at user-defined frequency such as, for example, in the range of once every minute to once an hour. In various embodiments, if deviations from the original optimal plan is detected, a plantwide re-optimization may be performed. In some embodiments, the output of the re-optimization may be sent to and implemented by the one or more secondary controllers.

The coarse-scale model may identify multiple process units. In some embodiments, the coarse-scale model represents a “bird's eye” view of the entire plant (or portion thereof), and thus represents individual process units on a coarse scale. The coarse-scale model may focus on the inter-unit steady relationships pertaining to unit productions, product qualities, material and energy balances, and/or manufacturing activities inside the plant 102. The coarse-scale model may include one or more process yield models and product quality properties. In some embodiments, the coarse-scale model may exclude non-production-related variables, such as pressures, temperatures, tank levels, and/or valve opening within each unit. In such embodiments, for example, the coarse-scale model may reduce the process unit to one or several material or energy yield vectors. In some examples, the coarse-scale model may comprise a planning model constructed from a combination of various sources, such as planning tools, scheduling tools, yield validation tools, and/or historical operation data. Such planning models are described in detail in U.S. Pat. No. 9,733,629 and, to supplement the present disclosure, this application incorporates entirely by reference U.S. Pat. No. 9,733,629.

A secondary controller 160 may be electronically and/or communicatively coupled to the plant 102, individual physical processing units of the plant 102, individual physical storage units of the plant 102, individual physical streams of the plant 102, one or more databases 150, the master controller 140, and/or one or more user devices 170. The secondary controller 160 may be located remotely, in proximity of, and/or within the plant 102. In some embodiments, the secondary controller 160 is configured via hardware, software, firmware, and/or a combination thereof, to perform data intake of one or more types of data associated with one or more of the plant 102, individual physical processing units of the plant 102, individual physical storage units of the plant 102, individual physical streams of the plant 102, one or more databases 150, the master controller 140, and/or one or more user devices 170. Additionally, or alternatively, in some embodiments, the secondary controller 160 is configured via hardware, software, firmware, and/or a combination thereof, to generate and/or transmit command(s) that control, adjust, or otherwise impact operations of plant 102, individual physical processing units of the plant 102, individual physical storage units of the plant 102, individual physical streams of the plant 102, one or more databases 150, the master controller 140, and/or one or more user devices 170, for example for controlling one or more operations of the plant 102. Additionally, or alternatively still, in some embodiments, the secondary controller 160 is configured via hardware, software, firmware, and/or a combination thereof, to perform data reporting and/or other data output process(es) associated with monitoring or otherwise analyzing operations of plant 102, individual physical processing units of the plant 102, individual physical storage units of the plant 102, individual physical streams of the plant 102, one or more databases 150, the master controller 140, and/or one or more user devices 170, for example for generating and/or outputting report(s) corresponding to the operations performed via the plant 102. For example, in various embodiments, the secondary controller 160 may be configured to execute and/or perform one or more operations and/or functions described herein.

In various embodiments, the master controller 140 is cascaded on top of the one or more secondary controllers 160. In this regard, in some embodiments, the master controller 140 (e.g., master MPC) and the one or more secondary controllers 160 (e.g., secondary MPC(s)) may collectively define a cascaded MPC architecture. In some such embodiments, the one or more secondary controllers 160 may interact with one or more process controllers. For example, in some embodiments, the one or more secondary controllers 160 may represent level 3 controllers, while the one or more process controllers may represent level 2 controllers. Each of the master controller 140 and the one or more secondary controllers 160 may be configured to support plantwide optimization and/or multivariable control functions. In some embodiments, plantwide optimization (or plantwide control) comprises optimization or control of multiple units in an industrial facility, regardless of whether those multiple units represent every single unit in the industrial facility. A secondary controller 160, for example, may be configured to optimize operations of an individual physical processing unit of the plant 102. In some embodiments, the one or more secondary controllers 160 may provide the master controller 140 with predictions, operating states, and/or constraints for each of one or more units of the plant 102. In this regard, in such some embodiments, the plantwide optimization from the master controller 140 may honor the unit-level operating techniques from the one or more secondary controllers 160. The MPC cascade technique, for example, may enable embedded real-time planning solutions to honor lower-level operating constraints.

The one or more secondary controllers 160 may use a secondary controller model that includes various operating variable for control purposes in order to ensure the safe and effective operation of a unit. In various embodiments, the secondary controller model may include more variables for a unit compared to the primary model of the master controller 140. As one non-limiting example, the secondary controller model for an oil refinery's Fluidized Catalytic Cracking unit (FCCU) may include about 100 secondary control CVs (e.g., outputs) and 40 secondary control MVs (e.g., inputs), where the planning model for the FCCU focus only on key causal relationships between the feed quality and operation modes (as inputs) and the FCCU product yield and quality (as outputs).

In some embodiments, the master controller 140 and/or the secondary controller 160 is associated with one or more CVs. In some embodiments, a CV is a variable and/or parameter that is controlled such that the CV's value is at or near a setpoint and/or within a desired range. Said differently, for example, a CV may be a variable and/or parameter that is the output of an optimization operation performed by the master controller 140 and/or the secondary controller 160. For example, a CV may be a variable and/or parameter that is representative of an output of a hydrocracking physical processing unit (e.g., an output of a hydrocracker).

In some embodiments, the master controller 140 and/or the secondary controller 160 is associated with one or more MVs. In some embodiments, a MV is a variable and/or parameter that is manipulated, moved, operated, and/or adjusted in order to alter the value of one or more CVs. Said differently, for example, a MV may be a variable and/or parameter that is the input of an optimization operation performed by the master controller 140 and/or the secondary controller 160. For example, a MV may be a variable and/or parameter that is representative of an input to a hydrocracking physical processing unit (e.g., a physical stream into a hydrocracker).

In some embodiments, one or more MVs may be conjoint MVs (e.g., a pair of conjoint MVs). In some embodiments, a conjoint MV is a MV that is the same variable (e.g., the same MV) for both the master controller 140 and/or the secondary controller 160. For example, a conjoint MV may be a variable and/or parameter that is representative of an input to a hydrocracking physical processing unit.

In some embodiments, the master controller 140 and one or more secondary controllers 160 may be configured to implement model predictive control (MPC) in order to optimize the plant 102, such as by performing an optimization operation. In this regard, in some embodiments, the master controller 140 may comprise an independent controller using a reduced model. In order for the master controller 140 to cascade over the one or more secondary controllers 160, the master controller 140 honors the constraints of the one or more secondary controllers 16, otherwise it may not be optimal or feasible to implement optimization of the plant 102. In some embodiments, to help avoid this situation, a proxy limit technique is used to merge multiscale models. In some embodiments, a proxy limit technique is a technique for representing the constraint(s) (e.g., limits of the constraints associated with MVs and/or CVs) of the secondary controller 160 in a master controller MV space associated with the master controller 140. In some embodiments, the system environment 100 may be implemented using a Purdue model of process control. Such proxy limit techniques, model predictive control, and Purdue model of process control are described in detail in U.S. Pat. Nos. 10,379,503 and 9,733,629 and, to supplement the present disclosure, this application incorporates entirely by reference U.S. Pat. Nos. 10,379,503 and 9,733,629.

The one or more databases 150 may be configured to receive, store, and/or transmit data. In some embodiments, the one or more databases 150 may be associated with data associated with the plant 102. In some embodiments, the data may be received from the plant 102. In this regard, for example, the plant 102 may have one or more sensors that capture data and/or one or more datastores that store data. In some embodiments, the data may be received from the master controller 140 and/or the secondary controller 160. In this regard, for example, the master controller 140 and/or the secondary controller 160 may be configured to identify data associated with the plant 102. In some embodiments, the one or more databases 150 may be associated with data received from the plant 102, the master controller 140, and/or the secondary controller 160 in real-time. Additionally, or alternatively, the one or more databases 150 may be associated with data received from the plant 102, the master controller 140, and/or the secondary controller 160 on a periodic basis (e.g., the data may be received from the plant 102, the master controller 140, and/or the secondary controller 160 once per day). Additionally, or alternatively, the one or more databases 150 may be associated with data received from the plant 102, the master controller 140, and/or the secondary controller 160 in response to a request for the data. Additionally, or alternatively, the one or more databases 150 may be associated with data inputted (e.g., by a user) into the master controller 140, the secondary controller 160, and/or the one or more user devices 170.

The one or more user devices 170 may be associated with users of the master controller 140. In various embodiments, the master controller 140 may generate and/or transmit a message, alert, or indication to a user via a user device 170. Additionally, or alternatively, a user device 170 may be utilized by a user to remotely access the master controller 140 and/or the secondary controller 160. This may be by, for example, an application operating on the user device 170. A user may access the master controller 140 remotely, including one or more visualizations, reports, and/or real-time displays.

Additionally, while FIG. 1 illustrates certain components as separate, standalone entities communicating over the network 130, various embodiments are not limited to this configuration. In other embodiments, one or more components may be directly connected and/or share hardware or the like. For example, in some embodiments, the master controller 140 may include the one or more databases 150, which may collectively be located in or at the plant 102.

It will be understood that while many of the aspects and elements presented in FIG. 1 are shown as discrete, separate elements, other configurations may be used in connection with the methods, apparatuses, computer readable media, and computer programs described herein, including configurations that combine, omit, separate, or add aspects or elements. The various functions of the system environment 100 may be performed by other arrangements of one or more computing devices or computing systems without departing from the scope of the present disclosure. For example, in some embodiments, the functions of one or more of the illustrated elements in FIG. 1 may be performed by a single computing device or by multiple computing devices, which devices may be local or cloud based.

Additionally, while FIG. 1 illustrates certain components as separate, standalone entities communicating over the network 130, various embodiments are not limited to this configuration. In other embodiments, one or more components may be directly connected and/or share hardware or the like. For example, in some embodiments, the master controller 140 may include the one or more databases 150, which may collectively be located in or at the plant 102.

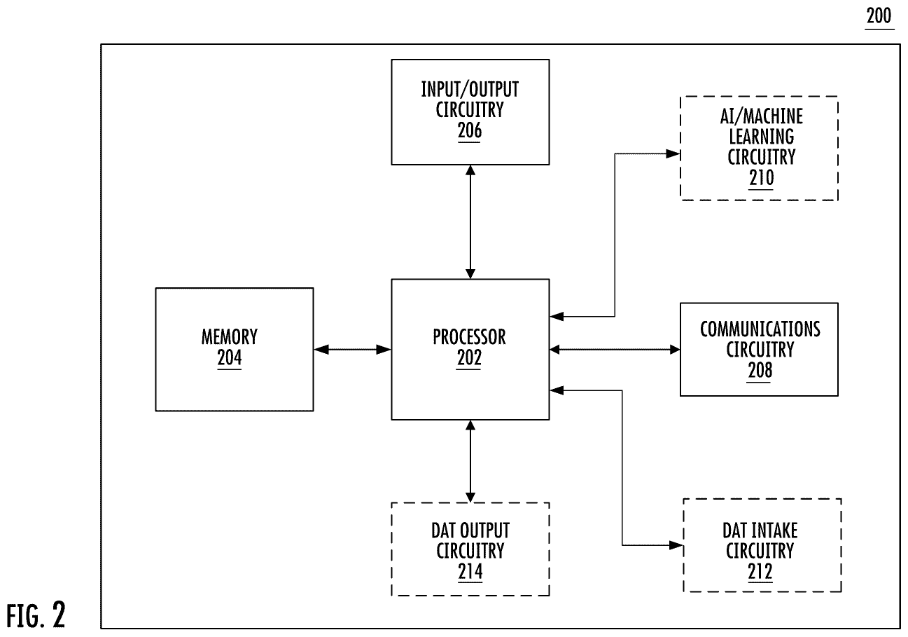

FIG. 2 illustrates an exemplary block diagram of an example apparatus that may be specially configured in accordance with an example embodiment of the present disclosure. Specifically, FIG. 2 depicts an example computing apparatus 200 (“apparatus 200”) specially configured in accordance with at least some example embodiments of the present disclosure. For example, the computing apparatus 200 may be embodied as one or more of a specifically configured personal computing apparatus, a specifically configured cloud-based computing apparatus, a specifically configured embedded computing device (e.g., configured for edge computing, and/or the like). Examples of an apparatus 200 may include, but is not limited to, a master controller 140, the secondary controller 160, the one or more databases 150, and/or a user device 170. The apparatus 200 includes processor 202, memory 204, input/output circuitry 206, communications circuitry 208, and/or optional artificial intelligence (“AI”) and machine learning circuitry 210. In some embodiments, the apparatus 200 is configured to execute and perform the operations described herein.

Although components are described with respect to functional limitations, it should be understood that the particular implementations necessarily include the use of particular computing hardware. It should also be understood that in some embodiments certain of the components described herein include similar or common hardware. For example, in some embodiments two sets of circuitry both leverage use of the same processor(s), memory(ies), circuitry(ies), and/or the like to perform their associated functions such that duplicate hardware is not required for each set of circuitry.

In various embodiments, such as computing apparatus 200 of the master controller 140, the secondary controller 160, and/or of the user device 170 may refer to, for example, one or more computers, computing entities, desktop computers, mobile phones, tablets, phablets, notebooks, laptops, distributed systems, servers, or the like, and/or any combination of devices or entities adapted to perform the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein. In one embodiment, these functions, operations, and/or processes can be performed on data, content, information, and/or similar terms used herein. In this regard, the apparatus 200 embodies a particular, specially configured computing entity transformed to enable the specific operations described herein and provide the specific advantages associated therewith, as described herein.

Processor 202 (or processor circuitry 202) may be embodied in a number of different ways. In various embodiments, the use of the terms “processor” should be understood to include a single core processor, a multi-core processor, multiple processors internal to the apparatus 200, and/or one or more remote or “cloud” processor(s) external to the apparatus 200. In some example embodiments, processor 202 may include one or more processing devices configured to perform independently. Alternatively, or additionally, processor 202 may include one or more processor(s) configured in tandem via a bus to enable independent execution of operations, instructions, pipelining, and/or multithreading.

In an example embodiment, the processor 202 may be configured to execute instructions stored in the memory 204 or otherwise accessible to the processor. Alternatively, or additionally, the processor 202 may be configured to execute hard-coded functionality. As such, whether configured by hardware or software methods, or by a combination thereof, processor 202 may represent an entity (e.g., physically embodied in circuitry) capable of performing operations according to embodiments of the present disclosure while configured accordingly. Alternatively, or additionally, processor 202 may be embodied as an executor of software instructions, and the instructions may specifically configure the processor 202 to perform the various algorithms embodied in one or more operations described herein when such instructions are executed. In some embodiments, the processor 202 includes hardware, software, firmware, and/or a combination thereof that performs one or more operations described herein.

In some embodiments, the processor 202 (and/or co-processor or any other processing circuitry assisting or otherwise associated with the processor) is/are in communication with the memory 204 via a bus for passing information among components of the apparatus 200.

Memory 204 (or memory circuitry 204) may be non-transitory and may include, for example, one or more volatile and/or non-volatile memories. In some embodiments, the memory 204 includes or embodies an electronic storage device (e.g., a computer readable storage medium). In some embodiments, the memory 204 is configured to store information, data, content, applications, instructions, or the like, for enabling an apparatus 200 to carry out various operations and/or functions in accordance with example embodiments of the present disclosure.

Input/output circuitry 206 may be included in the apparatus 200. In some embodiments, input/output circuitry 206 may provide output to the user and/or receive input from a user. The input/output circuitry 206 may be in communication with the processor 202 to provide such functionality. The input/output circuitry 206 may comprise one or more user interface(s). In some embodiments, a user interface may include a display that comprises the interface(s) rendered as a web user interface, an application user interface, a user device, a backend system, or the like. In some embodiments, the input/output circuitry 206 also includes a keyboard, a mouse, a joystick, a touch screen, touch areas, soft keys a microphone, a speaker, or other input/output mechanisms. The processor 202 and/or input/output circuitry 206 comprising the processor may be configured to control one or more operations and/or functions of one or more user interface elements through computer program instructions (e.g., software and/or firmware) stored on a memory accessible to the processor (e.g., memory 204, and/or the like). In some embodiments, the input/output circuitry 206 includes or utilizes a user-facing application to provide input/output functionality to a computing device and/or other display associated with a user.

Communications circuitry 208 may be included in the apparatus 200. The communications circuitry 208 may include any means such as a device or circuitry embodied in either hardware or a combination of hardware and software that is configured to receive and/or transmit data from/to a network and/or any other device, circuitry, or module in communication with the apparatus 200. In some embodiments the communications circuitry 208 includes, for example, a network interface for enabling communications with a wired or wireless communications network. Additionally, or alternatively, the communications circuitry 208 may include one or more network interface card(s), antenna(s), bus(es), switch(es), router(s), modem(s), and supporting hardware, firmware, and/or software, or any other device suitable for enabling communications via one or more communications network(s). In some embodiments, the communications circuitry 208 may include circuitry for interacting with an antenna(s) and/or other hardware or software to cause transmission of signals via the antenna(s) and/or to handle receipt of signals received via the antenna(s). In some embodiments, the communications circuitry 208 enables transmission to and/or receipt of data from a user device, one or more sensors, and/or other external computing device(s) in communication with the apparatus 200.

AI and machine learning circuitry 210 may be included in the apparatus 200. The AI and machine learning circuitry 210 may include hardware, software, firmware, and/or a combination thereof designed and/or configured to request, receive, process, generate, and transmit data, data structures, control signals, and electronic information for training and executing a trained AI and machine learning model configured for facilitating the operations and/or functionalities described herein. For example, in some embodiments the AI and machine learning circuitry 210 includes hardware, software, firmware, and/or a combination thereof, that identifies training data and/or utilizes such training data for training a particular machine learning model, AI, and/or other model to generate particular output data based at least in part on learnings from the training data. Additionally, or alternatively, in some embodiments, the AI and machine learning circuitry 210 includes hardware, software, firmware, and/or a combination thereof, that embodies or retrieves a trained machine learning model, AI and/or other specially configured model utilized to process inputted data. Additionally, or alternatively, in some embodiments, the AI and machine learning circuitry 210 includes hardware, software, firmware, and/or a combination thereof that processes received data utilizing one or more algorithm(s), function(s), subroutine(s), and/or the like, in one or more pre-processing and/or subsequent operations that need not utilize a machine learning or AI model.

Data intake circuitry 212 may be included in the apparatus 200. The data intake circuitry 212 may include hardware, software, firmware, and/or a combination thereof, designed and/or configured to capture, receive, request, and/or otherwise gather data associated with operations of the plant 102. In some embodiments, the data intake circuitry 212 includes hardware, software, firmware, and/or a combination thereof, that communicates with one or more sensor(s) unit(s), and/or the like within the plant 102 to receive particular data associated with such operations of the plant 102. Additionally, or alternatively, in some embodiments, the data intake circuitry 212 includes hardware, software, firmware, and/or a combination thereof, that retrieves particular data associated with the plant 102 from one or more data repository/repositories accessible to the apparatus 200.

Data output circuitry 214 may be included in the apparatus 200. The data output circuitry 214 may include hardware, software, firmware, and/or a combination thereof, that configures and/or generates an output based at least in part on data processed by the apparatus 200. In some embodiments, the data output circuitry 214 includes hardware, software, firmware, and/or a combination thereof, that generates a particular report based at least in part on the processed data, for example where the report is generated based at least in part on a particular reporting protocol. Additionally, or alternatively, in some embodiments, the data output circuitry 214 includes hardware, software, firmware, and/or a combination thereof, that configures a particular output data object, output data file, and/or user interface for storing, transmitting, and/or displaying. For example, in some embodiments, the data output circuitry 214 generates and/or specially configures a particular data output for transmission to another system sub-system for further processing. Additionally, or alternatively, in some embodiments, the data output circuitry 214 includes hardware, software, firmware, and/or a combination thereof, that causes rendering of a specially configured user interface based at least in part on data received by and/or processing by the apparatus 200.

In some embodiments, two or more of the sets of circuitries 202-214 are combinable. Alternatively, or additionally, one or more of the sets of circuitry 202-214 perform some or all of the operations and/or functionality described herein as being associated with another circuitry. In some embodiments, two or more of the sets of circuitry 202-214 are combined into a single module embodied in hardware, software, firmware, and/or a combination thereof. For example, in some embodiments, one or more of the sets of circuitry, for example the AI and machine learning circuitry 210, may be combined with the processor 202, such that the processor 202 performs one or more of the operations described herein with respect to the AI and machine learning circuitry 210.

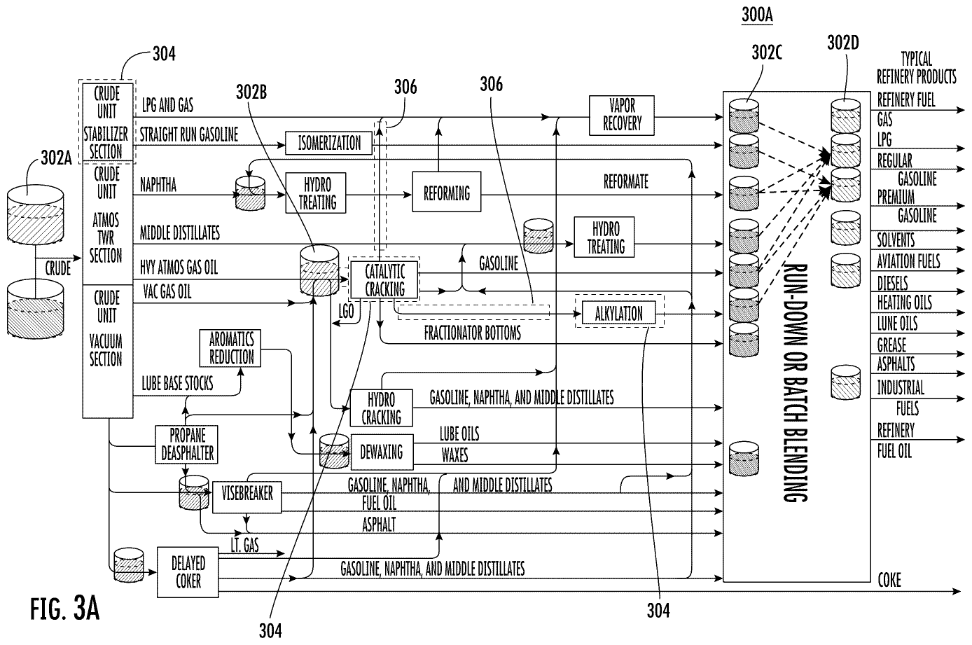

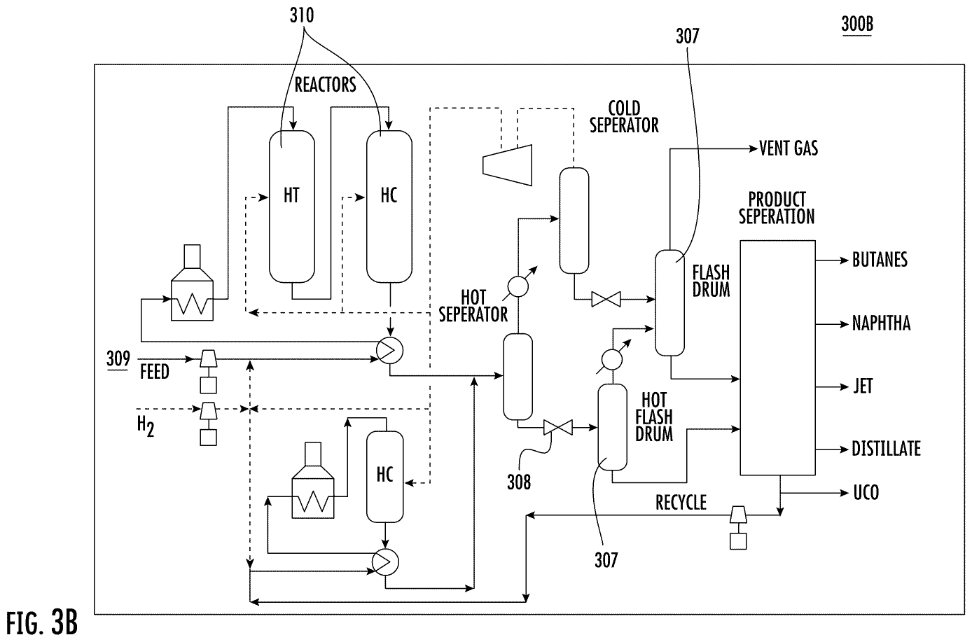

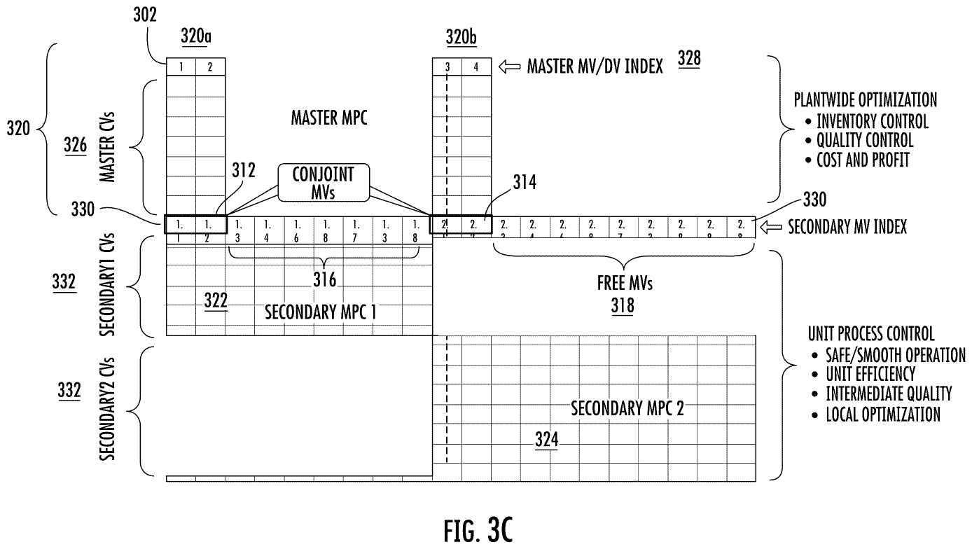

With reference to FIGS. 3A-C, in some embodiments, the master controller 140 and/or one or more secondary controllers 160 is configured to generate one or more models. In some embodiments, the master controller 140 and/or the one or more secondary controllers 160 is configured generate the one or more models using operational data. In some embodiments, operational data includes one or more items of data representative and/or indicative of operations of the plant 102. For example, operational data may be representative of any number of physical processing units, physical storage units, and/or physical streams included in the plant 102 (e.g., which physical processing units, physical storage units, and/or physical streams are included in the plant 102). As another example, operational data may be representative of one or more statuses associated with the plant 102 (e.g., what type of processed product the plant 102 is generating). In this regard, in some embodiments, the master controller 140 and/or the one or more secondary controllers 160 is configured to receive operational data from the plant 102 and use the operational data to generate one or more models. Additionally, or alternatively, the master controller 140 and/or the one or more secondary controllers 160 is configured to receive the one or more models. For example, the master controller 140 and/or the one or more secondary controllers 160 may be configured to receive the one or more models from the plant 102 and/or one or more external computing devices (e.g., the plant 102 and/or one or more external computing devices may be configured to generate the one or more models). In some embodiments, the one or more models comprise a master controller model 300A (e.g., flow sheet model) leveraged by the master controller 140 to facilitate and/or perform one or more functions of the master controller 140 and a secondary controller model 300B leveraged by a secondary controller 160 to facilitate and/or perform one or more functions of the secondary controller 160. In this regard, in some embodiments, the master controller 140 may be configured to generate or receive a master controller model 300A and a secondary controller 160 may be configured to generate or receive a secondary controller model 300B.

In some embodiments, the master controller model 300A (e.g., flow sheet model) is representative of a layout of the plant 102. In this regard, in some embodiments, the master controller model 300A is representative of a plurality of physical storage units 302 of the plant 102. In some embodiments, each of the plurality of physical storage units 302 is configured to store one or more processing materials. In some embodiments, the one or more processing materials include one or more input ingredients. For example, the one or more input ingredients may include raw materials and/or ingredients upon which the plant 102 has not performed any processing (e.g., crude oil). In some embodiments, the one or more processing materials include one or more intermediate ingredients. For example, the one or more intermediate ingredients may include partially processed materials and/or partially processed ingredients upon which the plant 102 has performed some processing but has not completed processing. In some embodiments, the one or more processing materials include one or more processed products. For example, the one or more processed products may include processed materials and/or processed products upon which the plant 102 has completed processing (e.g., aviation fuel).

In some embodiments, the plurality of physical storage units 302 includes any number of the types of physical storage units described above. For example, the plurality of physical storage units 302 may include one or more input physical storage units 302A. In some embodiments, the one or more input physical storage units 302A are configured to store processing materials that include one or more input ingredients. As another example, the plurality of physical storage units 302 may include one or more intermediate physical storage units 302B. In some embodiments, the one or more intermediate physical storage units 302B are configured to store processing materials that include one or more intermediate ingredients. As another example, the plurality of physical storage units 302 may include one or more component physical storage units 302C. In some embodiments, the one or more component physical storage units 302C are configured to store processing materials that include one or more intermediate ingredients. As another example, the plurality of physical storage units 302 may include one or more processed product physical storage units 302D. In some embodiments, the one or more processed product physical storage units 302D are configured to store processing materials that include one or more processed products.

In some embodiments, the master controller model 300A is representative of a plurality of physical processing units 304 of the plant 102. In some embodiments, the plurality of physical processing units 304 include any number of the types of physical processing units described above. For example, the plurality of physical storage units 302 may include a catalytic cracking processing unit. In some embodiments, the master controller model 300A is representative of a plurality of physical streams 306 of the plant 102. In some embodiments, the plurality of physical streams 306 include any number of the types of physical streams described above. For example, the plurality of physical streams 306 may include a naphtha physical stream. Additionally, or alternatively, the master controller model 300A is representative of one or more relationships and/or connections between the plurality of physical storage units 302, the plurality of physical processing units 304, and/or the plurality of physical streams 306. For example, the master controller model 300A may indicate that one or more of the plurality of physical storage units 302 are connected to one or more of the plurality of physical processing units 304 via one or more of the plurality of physical streams 306.

In some embodiments, the secondary controller model 300B is representative of a layout of a process unit. In some embodiments, the secondary controller model 300B is representative of a plurality of components of a single processing unit of the plant 102 such as, for example, various component of a catalytic cracking processing unit or any other processing unit of the plant 102. By way of example, and as shown in the illustrated example secondary controller model 300B, the one or more components may comprise one or more valves and/or other actuators 308 leveraged to adjust operations within the processing unit; one or more reactors 310, one or more flash drums 307, one or more physical storage units, and/or other components of the processing unit. In some embodiments, the one or more physical storage units includes any number of the types of physical storage units described above. In some embodiments, the secondary controller model 300B is representative of a plurality of physical streams of the processing unit. In some embodiments, the plurality of physical streams includes any number of the types of physical streams described above. For example, the plurality of physical streams may include hydrogen feed 309 and/or other input feed. Additionally, or alternatively, the secondary controller model 300B is representative of one or more relationships and/or connections between the plurality of components and physical streams of the processing unit. For example, the secondary controller model 300B may indicate connections and/or relationships between components (e.g., reactors 310, flash drum 307, and/or the like) and/or physical streams within the processing unit.

In some embodiments, the master controller model 300A excludes non-production related variables such as pressures, temperatures, tank levels, and valve openings within the processing units. In this regard, the master controller model 300A may reduce a processing unit to one or several material or energy yield vectors. The secondary controller model 300B may include various operating variables for control purposes in order to, for example, facilitate safe and effective operation of the processing unit. In this regard, the secondary controller model 300B may comprise more variables for a processing unit relative to the master controller model 300A. As one non-limiting example, the secondary controller model for an oil refinery's fluidized catalytic cracking unit (FCCU) may include about 100 secondary controller CVs (e.g., outputs) and 40 secondary controller MVs (e.g., inputs), where the master controller model for the FCCU focus only on key causal relationships between the feed quality and operation modes (as inputs) and the FCCU product yield and quality (as outputs). In this regard, in some embodiments, the master controller model 300A may represent a coarse-scale model and the secondary controller model 300B may represent a finer-scale model. In some examples, a secondary controller model's time horizon may range from minutes to hours, while a master controller model's time horizon may range from days to months.

Referencing FIG. 3C, which illustrates a matrix representation (e.g., tabular graph representation) of example master controller model 300A and secondary controller model 300B. Specifically, FIG. 3C illustrates a master controller model matrix 320 corresponding to a master controller model 300A of a master controller 140, a secondary controller model matrix 322 corresponding to a secondary controller model 300B of a first secondary controller, and a secondary controller model matrix 324 corresponding to a secondary controller model 300B of a second secondary controller.

The master controller model matrix 320 may comprise a MV/disturbance variable index 328 (e.g., MV/DV index) that identifies one or more master controller MVs and/or one or more master controller disturbance variables used by the master controller 140 to facilitate and/or perform one or more functions thereof. One or more master controller CVs 326 controlled by the master controller 140 may be affected by the one or more master controller MVs and/or the one or more master controller disturbance variables.

In some examples and as shown in FIG. 3C, the illustrated example master controller model matrix 320 may be portioned into multiple columns comprising a first group 320a and a second group 320b. The master controller model matrix 320 may be representative and/or indicative of connections between the master controller MV(s) and master controller CVs 326. Alternatively, or additionally, the master controller model matrix 320 may be representative and/or indicative of master controller MVs that affect a given master controller CV. In some examples, a given row (or portion of a row) within the master controller model matrix 320 may be representative and/or indicative of a set of master controller CV constraints (e.g., constraints associated with a particular master controller CV).

Each of the secondary controller model matrix 322, 324 may comprise a respective MV/disturbance variable index 330 (e.g., MV/DV index) that identifies one or more secondary controller MVs and/or one or more secondary controller disturbance variables used by the respective secondary controller 160 to facilitate and/or perform one or more functions thereof. A respective set of secondary controller CVs 332, controlled by the first and second secondary controllers may be affected by a respective set of corresponding secondary controller MVs and/or a respective set of one or more secondary controller disturbance variables. The secondary controller model matrix 322, 324 may be representative and/or indicative of connections between the secondary controller MV(s) and secondary controller CVs. Alternatively, or additionally, the secondary controller model matrix 322, 324 may be representative and/or indicative of secondary controller MVs that affect a given secondary controller CV. In some examples, a given row (or portion of a row) within a secondary controller model matrix may be representative and/or indicative of a set of secondary controller CV constraints (e.g., constraints associated with a particular secondary controller CV).

In some embodiments, the master controller 140 and a secondary controller 160 may comprise a set of conjoint MVs. For example, the master controller 140 and a first secondary controller (e.g., associated with the secondary controller model matrix 322) may comprise a set of conjoint MVs 312. As another example, the master controller 140 and the second secondary controller (e.g., associated with the secondary controller model matrix 324) may comprise a set of conjoint MVs 314. A conjoint MV may represent the same MV represented in both a master controller 140 and a secondary controller 160. By way of example, a first master controller MV for the master controller 140 may correspond to the feed rate of a hydrocracking physical processing unit and a first secondary controller MV for a secondary controller 160 may also correspond the feed rate of the hydrocracking physical processing unit, wherein the master controller 140 may leverage the first master controller MV (e.g., feed rate of the hydrocracking physical processing unit) for plantwide inventory and/or quality control, while the secondary controller 160 leverages the first secondary controller MV (e.g., the same feed rate of the hydrocracking physical processing unit) to achieve its local control tasks. In this regard, these connected MVs (e.g., first master controller MV and first secondary controller MV) may be denoted or otherwise represented as conjoint MVs. In some examples, a conjoint MV may cause the overall system to lose certain degree of freedom, for example, because the master controller 140 and the secondary controller 160 may have to agree to a single value, not two independent values. In this regard, the conjoint MVs such as the set of conjoint MVs 312 and the set of conjoint MVs 314 are the variables that conjoin the master controller 140 and a secondary controller 160 together.

As shown in FIG. 3C, a secondary controller 160 (e.g., secondary controller model 300B thereof) may comprise one or more non-conjoint MVs (e.g., set of non-conjoint MVs 316, 318). The one or more non-conjoint MVs may be representative and/or indicative of free secondary controller MVs. In some embodiments, the one or more non-conjoint MVs may be directed or moved by the respective secondary controller 160 unilaterally.

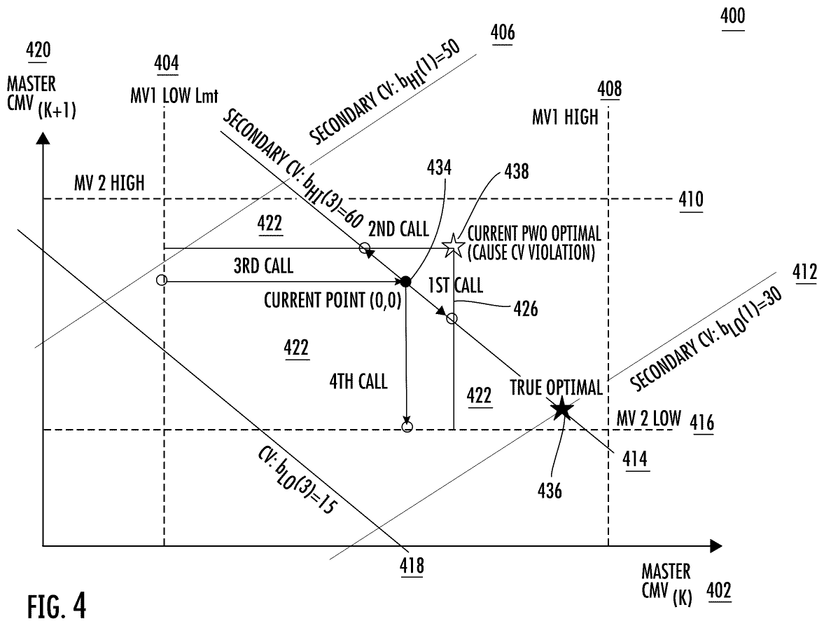

Referencing FIG. 4, in some embodiments, the master controller 140 and/or a secondary controller 160 is configured to generate a master controller MV space 400. In some examples, the master controller 140 and/or the secondary controller 160 may be configured to generate the master controller MV space 400 using a proxy limit technique. In some embodiments, the master controller MV space 400 is a space for representing constraint(s) (e.g., constraints associated with MVs and/or CVs) of a secondary controller 160 in relation to the master controller 140.

In some embodiments, the master controller MV space 400 corresponds to a set of master controller MVs. In some embodiments, the set of master controller MVs comprises a first master controller MV and/or a second master controller MV. In this regard, in some embodiments, a first axis 402 (e.g., Master CMV (k)) of the master controller MV space 400 corresponds to the first master controller MV. In some embodiments, a second axis 420 (e.g., Master CMV (k+1)) of the master controller MV space 400 corresponds to the second master controller MV.

In some embodiments, the master controller MV space 400 corresponds to a set of secondary controller MVs. For example, the set of secondary controller MVs may comprise a first secondary controller MV and/or a second secondary controller MV.

In some embodiments, the first secondary controller MV may have a low limit 404 (e.g., MV1 Low). In some embodiments, the low limit 404 may be a limit that the secondary controller 160 is unable to go below for the first secondary controller MV. For example, the low limit 404 may be a limit of a first physical stream (e.g., lowest possible flow rate of the first physical stream) that the secondary controller 160 is unable to go below. In some embodiments, the first secondary controller MV may have a high limit 408 (e.g., MV1 High). In some embodiments, the high limit 408 may be a limit that the secondary controller 160 is unable to go above for the first secondary controller MV. For example, the high limit 408 may be a limit of a first physical stream (e.g., highest possible flow rate of the first physical stream) that the secondary controller 160 is unable to go above.

In some embodiments, the second secondary controller MV may have a low limit 416 (e.g., MV2 Low). In some embodiments, the low limit 416 may be a limit that the secondary controller 160 is unable to go below for the second secondary controller MV. For example, the low limit 416 may be a limit of a second physical stream (e.g., lowest possible flow rate of the second physical stream) that the secondary controller 160 is unable to go below. In some embodiments, the second secondary controller MV may have a high limit 410 (e.g., MV2 High). In some embodiments, the high limit 410 may be a limit that the secondary controller 160 is unable to go above for the second secondary controller MV. For example, the high limit 410 may be a limit of a second physical stream (e.g., highest possible flow rate of the second physical stream) that the secondary controller 160 is unable to go above.

In some embodiments, the set of master controller MVs and the set of secondary controller MVs may be conjoint MVs. For example, the first master controller MV and the first secondary controller MV may be conjoint MVs (e.g., Conj Vars). As another example, the second master controller MV and the second secondary controller MV may be conjoint MVs.

In some embodiments, the master controller MV space 400 corresponds to a set of secondary controller CVs. For example, the set of secondary controller CVs may comprise a first secondary controller CV and/or a second secondary controller CV.

In some embodiments, the first secondary controller CV may have a low limit 412 (e.g., Secondary CV: b_{LO}(1)=30). In some embodiments, the low limit 412 may be a limit that the secondary controller 160 is unable to go below for the first secondary controller CV. For example, the low limit 412 may be a limit of a first physical processing unit (e.g., lowest possible output of the first physical processing unit) that the secondary controller 160 is unable to go below. In some embodiments, the first secondary controller CV may have a high limit 406 (e.g., Secondary CV: b_{HI}(1)=50). In some embodiments, the high limit 406 may be a limit that the secondary controller 160 is unable to go above for the first secondary controller CV. For example, the high limit 406 may be a limit of a first physical processing unit (e.g., highest possible output of the first physical processing unit) that the secondary controller 160 is unable to go above.

In some embodiments, the second secondary controller CV may have a low limit 418 (e.g., Secondary CV: b_{LO}(3)=15). In some embodiments, the low limit 418 may be a limit that the secondary controller 160 is unable to go below for the second secondary controller CV. For example, the low limit 418 may be a limit of a second physical processing unit (e.g., lowest possible output of the second physical processing unit) that the secondary controller 160 is unable to go below. In some embodiments, the second secondary controller CV may have a high limit 414 (e.g., Secondary CV: b_{HI}(3)=60). In some embodiments, the high limit 414 may be a limit that the secondary controller 160 is unable to go above for the second secondary controller CV. For example, the high limit 414 may be a limit of a second physical processing unit (e.g., highest possible output of the second physical processing unit) that the secondary controller 160 is unable to go above.

In some embodiments, the master controller 140 and/or the secondary controller 160 is associated with an operating point 434. In some embodiments, the operating point 434 is the current operating point of one or more MVs associated with the master controller 140 and/or the secondary controller 160. For example, the operating point 434 may be the current operating point of one or more of the first master controller MV, the first secondary controller MV, the second master controller MV, and/or the second secondary controller MV (e.g., a current flow rate in a physical stream of the plant 102). Said differently, for example, the operating point 434 may be a current operating point of one or more conjoint MVs of the master controller 140 and/or the secondary controller 160. In some embodiments, the operating point 434 is represented in the master controller MV space 400 as a set of coordinates, such as (0,0). For example, the operating point 434 may represent the starting operating point for an optimization iteration.

In some embodiments, the operating point 434 is within a feasible operating region 422 (e.g., anywhere within the feasible operating region 422). In some embodiments, the feasible operating region 422 is a region in which the one or more MVs associated with the master controller 140 and/or the secondary controller 160 may be able to be manipulated, moved, operated, adjusted, and/or the like while ensuring that the master controller 140 can adhere to the constraints of the secondary controller 160 (e.g., the constraints associated with MVs and/or CVs of the secondary controller 160). For example, the one or more MVs may be operated, adjusted, moved, and/or the like within the feasible operating region 422 in order to optimize the plant 102, individual physical processing units of the plant 102, individual physical storage units of the plant 102, individual physical streams of the plant 102. In this regard, in some embodiments, the feasible operating region 422 may be defined at least in part by one or more of the low limit 404, the low limit 416, the low limit 412, the low limit 418, the high limit 408, the high limit 410, the high limit 406, and/or the high limit 414. Said differently, for example, the feasible operating region 422 defines the possible combinations of values that could be selected by the master controller 140 while satisfying all constraints of the secondary controller 160.

In some embodiments, the master controller 140 and/or the secondary controller 160 is associated with an optimal operating point 436. In some embodiments, the optimal operating point 436 is the optimal and/or ideal operating point of one or more MVs associated with the master controller 140 and/or the secondary controller 160. For example, the optimal operating point 436 may be the optimal and/or ideal operating point of one or more of the first master controller MV, the first secondary controller MV, the second master controller MV, and/or the second secondary controller MV (e.g., a current flow rate in a physical stream of the plant 102). Said differently, for example, the optimal operating point 436 may be an optimal and/or ideal operating point of one or more conjoint MVs of the master controller 140 and/or the secondary controller 160 in order to optimize the plant 102, individual physical processing units of the plant 102, individual physical storage units of the plant 102, and/or individual physical streams of the plant 102.

In some embodiments, one or more of the low limit 404, the high limit 408, the low limit 416, the high limit 410, the low limit 412, the high limit 406, the low limit 418, and/or the high limit 414 comprise one or more limit positions. For example, one or more of the low limit 404, the high limit 408, the low limit 416, the high limit 410, the low limit 412, the high limit 406, the low limit 418, and/or the high limit 414 comprise one or more of a set of limit positions, an additional set of limit positions, and/or other limit positions. In some embodiments, a limit position is a particular position on one or more of the low limit 404, the high limit 408, the low limit 416, the high limit 410, the low limit 412, the high limit 406, the low limit 418, and/or the high limit 414. In some embodiments, a limit position may represent a limit or maximum amount one or more MVs associated with the secondary controller 160 and/or the master controller 140 may be manipulated, moved, operated, adjusted, and/or the like while still staying within the constraint(s) of the secondary controller 160. In this regard, in some embodiments, at least one of a set of limit positions is defined by one or more of the set of secondary controller MVs associated with the secondary controller 160. In some embodiments, a limit position may be referred to as a proxy limit value.

In some embodiments, the master controller 140 and/or the secondary controller 160 is configured to determine the limit positions (e.g., proxy limit values) using band-search techniques and/or other techniques. In some embodiments, the master controller 140 is configured to receive one or more limit positions of a set of limit positions from the secondary controller 160. In some embodiments, the master controller 140 is configured to receive one or more limit positions of a set of limit positions from the secondary controller 160 in response to transmitting a first optimization request to the secondary controller 160. For example, the master controller 140 may be configured to receive a first limit position of a set of limit positions from the secondary controller 160. In this regard, in some embodiments, the secondary controller 160 is configured to determine one or more limit positions in response to receiving a first optimization request. For example, the secondary controller 160 may be configured to solve one or more computing problems (e.g., an optimization problem) in order to determine one or more limit positions.

In some embodiments, the master controller 140 is configured to receive one or more additional limit positions of an additional set of limit positions from the secondary controller 160. In some embodiments, the master controller 140 is configured to receive one or more additional limit positions of an additional set of limit positions from the secondary controller 160 in response to transmitting a second optimization request to the secondary controller 160. For example, the master controller 140 may be configured to receive a first additional limit position of a set of limit positions from the secondary controller 160. Said differently, for example, for each optimization request the master controller 140 transmits to the secondary controller 160, the master controller 140 may receive one or more limit positions in response.

In some embodiments, the master controller 140 and/or the secondary controller 160 is configured to determine an estimated feasible operating region 426 based on the one or more limit positions (e.g., proxy limit values), such as one or more limit positions received from and/or determined by the secondary controller 160. For example, the master controller 140 and/or the secondary controller 160 may be configured to determine the estimated feasible operating region 426 based on the first limit position corresponding to a first optimization request, a first additional limit position corresponding to a second optimization request, and/or one or more other limit positions corresponding to one or more other optimization requests.

In some embodiments, the estimated feasible operating region 426 is an estimation or approximation of the feasible operating region 422. In this regard, in some embodiments, using one or more limit positions received from and/or determined by the secondary controller 160, the master controller 140 and/or the secondary controller 160 is able to determine limits and/or boundaries (e.g., bounds) of operation of the secondary controller 160 that are imposed by constraints associated with the secondary controller 160. For example, using one or more limit positions received from and/or determined by the secondary controller 160, the master controller 140 and/or the secondary controller 160 is able to determine limits and/or boundaries of operation of the secondary controller 160 that are imposed by the low limit 404, low limit 416, the low limit 412, low limit 418, the high limit 408, the high limit 410, the high limit 406, and/or the high limit 414. In some embodiments, based on these determined limits and/or boundaries of operation of the secondary controller 160, the master controller 140 and/or the secondary controller 160 is configured to determine the estimated feasible operating region 426 (e.g., by approximating and/or estimating the feasible operating region 422). Limit positions (e.g., proxy limits), band-search techniques, and estimated feasible operating region are described in detail in U.S. patent application Ser. No. 19/069,817 and, to supplement the present disclosure, this application incorporates entirely by reference U.S. patent application Ser. No. 19/069,817.

In some embodiments, the estimated feasible operating region 426 is associated with an area. In some embodiments, the area of the estimated feasible operating region 426 may be different than a second area of the feasible operating region 422 (e.g., since the estimated feasible operating region 426 may be an estimate and/or approximation of the feasible operating region 422). For example, the second area of the feasible operating region 422 may be greater than the area of the estimated feasible operating region 426.

In some embodiments, the master controller 140 and/or the secondary controller 160 is associated with a predicted optimal operating point 438 (e.g., current PWO operating point).

In some embodiments, the predicted optimal operating point 438 is the current operating point predicted by the master controller 140 and/or secondary controller 160 as the optimal operating point of one or more MVs associated with the master controller 140 and/or the secondary controller 160. For example, the predicted optimal operating point 438 may be the current operating point predicted by the master controller 140 and/or secondary controller 160 as the optimal operating point of one or more of the first master controller MV, the first secondary controller MV, the second master controller MV, and/or the second secondary controller MV (e.g., a current flow rate in a physical stream of the plant 102). Said differently, for example, the predicted optimal operating point 438 may be current operating point predicted by the master controller 140 and/or secondary controller 160 as the optimal operating point of one or more conjoint MVs of the master controller 140 and/or the secondary controller 160. In some embodiments, the predicted optimal operating point 438 may be an output of an optimization iteration. In some embodiments, the predicted optimal operating point 438 may serve as the operating point 434 (e.g., current operating point) for a subsequent optimization iteration.

In some embodiments, the master controller 140 and/or the secondary controller may be configured to determine the predicted optimal operating point 438 based on the estimated feasible operating region 426. For example, in such some embodiments, the predicted optimal operating point 438 is within an estimated feasible operating region 426 (e.g., anywhere within the estimated feasible operating region 426 including, for example, on a corner of an area defined by the estimated feasible operating region 426). In this regard, in some embodiments, the master controller 140 and/or the secondary controller 160 may be configured to perform one or more optimization iterations based on the estimated feasible operating region 426 to determine the predicted optimal operating point 438. For example, in some embodiments, the predicted optimal operating point 438 may comprise an output of an optimization iteration performed by the master controller 140.

The one or more optimization iterations, for example, may be performed in order to achieve the optimal operating point 436, wherein the output of an optimization iteration comprises the predicted optimal operating point 438. Said differently, a goal of the one or more optimization iterations may be to cause operation of the plant 102, individual physical processing units of the plant 102, individual physical storage units of the plant 102, and/or individual physical streams of the plant 102 at the optimal operating point 436, thereby optimizing the plant 102, individual physical processing units of the plant 102, individual physical storage units of the plant 102, and/or individual physical streams of the plant 102. In this regard, in some embodiments, an optimization iteration may be configured to cause the operating point 434 to move closer towards the optimal operating point 436.

In some embodiments, the master controller model 300A of the master controller 140 is dynamically augmented with at least one secondary controller CV from the set of secondary controller CVs associated with a secondary controller 160. In some embodiments, the master controller model 300A is dynamically augmented with the at least one secondary controller CV thereof in response to determining that the secondary controller CVs satisfies one or more co-control criteria. In some embodiments, dynamically augmenting the master controller model 300A with a secondary controller CV comprises incorporating/representing constraints associated with the secondary controller CV (e.g., secondary controller CV constraints) within the master controller model 300A along with control bounds (e.g., low control bound and/or high control bound) for the secondary controller CV constraint.

In some embodiments, the one or more co-control criteria may comprise (i) any non-conjoint secondary controller CV constraint (e.g., constraint associated with a non-conjoint secondary controller CV constraint) predicted to be violated by the predicted optimal operating point 438, (ii) any secondary controller CV constraint predicted to be within a predefined threshold distance from its limits and/or bounds within a defined tolerance (e.g., any secondary controller CV constraint predicted to be near its limits and/or bounds within a user-defined tolerance), and/or (iii) any CV constraint that currently violates its limits and/or bounds without MV moves/adjustments with respect to the operating point 434, wherein the one or more co-control criteria may be satisfied if at least one co-control criteria from the one or more co-control criteria is satisfied.

In this regard, in some embodiments, the system (e.g., using the master controller 140 and/or the secondary controller 160) may be configured to determine if the predicted optimal operating point 438 violates any non-conjoint secondary controller CV constraints such as constraints associated with the first secondary controller CV and/or constraints associated with the second secondary controller CV. Alternatively, or additionally, the system (e.g., using the master controller 140 and/or the secondary controller 160) may be configured to determine if any secondary controller CV constraint, such as constraints associated with the first secondary controller CV and/or constraints associated with the second secondary controller CV is within a threshold distance from its limits and/or bounds (e.g., close to its limits or bounds). Alternatively, or additionally, the system (e.g., using the master controller 140 and/or the secondary controller 160) may be configured to determine if any CV constraint currently violates its limits and/or bounds without MV moves/adjustments with respect to the operating point 434. In this regard, in some embodiments, the master controller MV space 400, the feasible operating region 422, the estimated feasible operating region 426, and/or the predicted optimal operating point 438 may be leveraged to determine if any of the constraints associated with the set of secondary controller CVs or other secondary controller CVs satisfy the one or more co-control criteria. By way of example, one or more constraints associated with the first secondary controller CV and/or one or more constraints associated with the second secondary controller CV may be determined to satisfy the one or more co-control criteria.

Still referencing FIG. 4, and by way of example, the one or more co-control criteria may be satisfied in certain scenarios, such as those where the master controller 140 is riding on a secondary controller CV constraint. Said differently, the one or more co-control criteria may be satisfied in scenarios such as where the operating point 434 is on a constraint of a secondary controller CV, as depicted in FIG. 4. In this regard, in some scenarios the predicted optimal operating point 438 may be outside of the feasible operating region 422 (e.g., not within the feasible operating region 422), which causes violation of constraints associated with secondary controller CV(s). For example, as shown in FIG. 4, the predicted optimal operating point 438 causes violation of constraints associated with second secondary controller CV (e.g., CV3). Additionally, as shown in the illustrated example of FIG. 4, the predicted optimal operating point 438 is far away from the optimal operating point 436. In this regard, optimization of the plant 102, individual physical processing units of the plant 102, individual physical storage units of the plant 102, and/or individual physical streams of the plant 102 is not achieved.

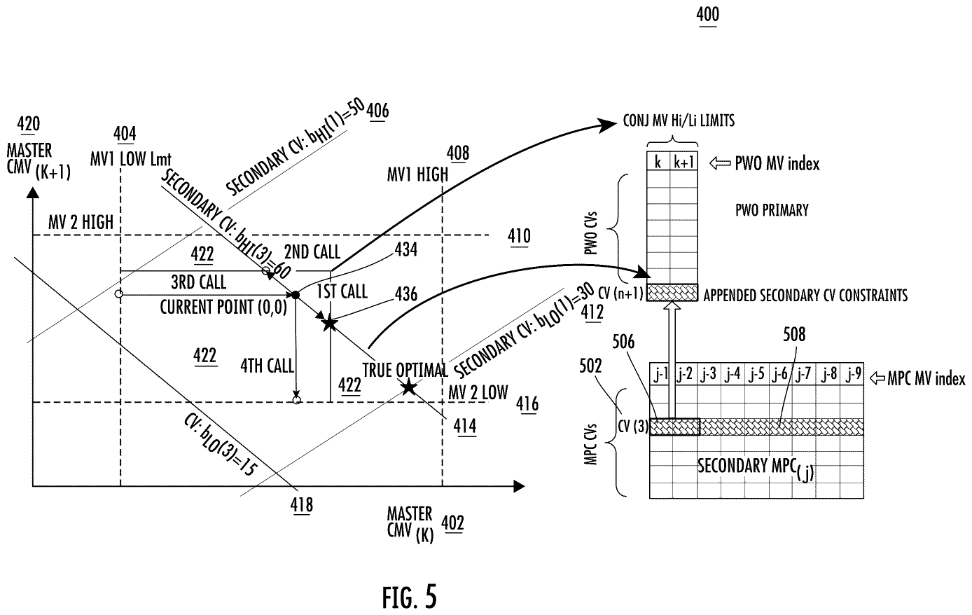

For example, in some scenarios, the feasible operating region 422 may form a slanted belt, making it challenging to cast the feasible operating region 422 into the estimated feasible operating region 426. In such scenarios, adjusting the proxy limit search bandwidth (e.g., increasing or decreasing the proxy limit search bandwidth may not suffice to solve the issue). Moreover, given that the predicted optimal operating point 438 is far away from the optimal operating point 436, the number of optimization iterations to move/adjust the predicted optimal operating point 438 towards the optimal operating point 436 may increase significantly and may be a difficult path without violating constraints associated with one or more secondary controller CVs. In this regard, augmenting the master controller model 300A with secondary CV constraints that satisfy the one or more co-control criteria allows for co-control by the master controller 140 and a secondary controller 160, in order to allow for effective optimization while honoring constraints associated with the secondary controller 160. For example, as shown in FIG. 5, augmenting the master controller model 300A with constraints associated with the second secondary controller CV allows for co-control by the master controller 140 and the secondary controller 160, to maintain the second secondary controller CV on or below its high limit 414 (e.g., Secondary CV: b_{HI}(3)=60).

In some embodiments, the master controller 140 and/or the secondary controller 160 is configured to determine the control bounds for a selected secondary controller CV constraint (e.g., a secondary controller CV constraint that satisfies the one or more co-control criteria) for each optimization iteration based on (i) the set of non-conjoint MVs associated with the secondary controller CV and/or a (ii) configurable tuning parameter. Said differently, in some embodiments, the co-control bounds for a selected secondary controller CV constraint represented in the master controller model 300A is caused to relax at each optimization iteration based on the set of non-conjoint MVs associated with the secondary controller CV, wherein the amount by which the co-control bounds are caused to relax is based on the tuning parameter. In some embodiments, the secondary controller CV constraint and the co-control bounds are represented in the master controller model 300A as:

$$CoCV\_Lo \leq {G}_{act \_ ind , conj \_ ind} \cdot {x}_{conj} \leq CoCV\_Hi$$

$$for the i - th element in CoCV bounds :$$

$${CoCV\_Lo}_{i} = {CV\_Lo}_{act \_ ind ( i )} + λ \cdot {arg min}_{{x}_{free}} \{ - {G}_{act \_ ind ( i ) , free} \cdot {x}_{free} \}$$

$$\begin{matrix}{CoCV\_Hi}_{i} = {CV\_Hi}_{act \_ ind ( i )} + λ \cdot {arg min}_{{x}_{free}} \{ - {G}_{act \_ ind ( i ) , free} \cdot {x}_{free} \} \\ = {CV\_Hi}_{act \_ ind ( i )} - λ \cdot {arg min}_{{x}_{free}} \{ {G}_{act \_ ind ( i ) , free} \cdot {x}_{free} \}\end{matrix}$$

$$both s . t . {CV\_Lo}_{k \neq act \_ ind ( i )} \leq {G}_{k \neq act \_ ind ( i ) , free} \cdot {x}_{free} \leq {CV\_Hi}_{k \neq act \_ ind ( i )}$$

$${MV\_Lo}_{free} \leq {x}_{free} \leq {MV\_Hi}_{free}$$

$$λ is a co - control tuning factor , 0 \leq λ \leq 1 ( default \approx 0.5 )$$

Where, G may represent the secondary controller model matrix, either dynamic or steady-state, G_{act_ind, conj_ind}·x_{conj} may represent the active secondary controller CV set to be appended to the master controller model matrix, in some embodiments, below 320a/b in FIG. 3C or as an insert CV(n+1) in FIG. 5, CoCV_Lo may represent a co-control lower bound for the active secondary controller CV constraint set within the master controller, CoCV_Hi may represent a co-control upper bound for the active secondary controller CV constraint set within the master controller,

$${argmax}_{{x}_{free}} \{ - {G}_{act \_ ind {( i )}_{, free}} \cdot {x}_{free} \}$$

may represent the maximum range of assistive control providable by the non-conjoint MVs associated with the secondary controller, and/may represent the tuning parameter. In some embodiments, the tunning parameter is configurable. In some embodiments, the tuning parameter may be selected from a range of 0 and 1. For example, in some embodiments, a tuning parameter of 0.5 may be selected as the default tuning parameter.

Referencing FIG. 5 and for illustration, in some embodiments, dynamically incorporating/representing secondary controller CV constraints, such as constraints associated with the second controller CV, into the master controller model 300A comprise, identifying a first portion 506 (e.g., conjoint MV portion) of the model row 502 in the secondary controller model matrix 322, wherein the first portion 506 is representative of constraints associated with the second secondary controller CV, and appending the identified first portion 506 to the master controller model matrix 320. For example, the first portion 506 corresponds to the non-conjoint MVs associated with the second secondary controller CV. In some embodiments, a second portion 508 of the model row 502 corresponds to the non-conjoint MVs associated with the second secondary controller CV.

In some embodiments, a model matrix G may be partitioned and represented within the secondary controller model 300B as:

CV_Lo≤G_{conj}·x_{conj}+G_{free}·x_{free}≤CV_Hi

Where, G_{conj}·x_{conj} may represent a set of secondary controller CV constraints and correspond to conjoint secondary controller MVs (e.g., the first portion 506 of the model row) associated with a secondary controller CV, G_{free}·x_{free} may represent the non-conjoint MVs associated with the secondary controller CV (e.g., the second portion 508 of the model row), CV_Lo may represent the low control bound for the set of secondary controller CV constraints, and CV_Hi may represent the high control bound for the set of secondary controller CV constraints. In some embodiments, the low and high control limits/bounds (e.g., CV_Lo and CV_Hi) comprise the limits/bounds of the secondary controller CV under a default condition/assumption that the non-conjoint MVs are not moved/adjusted (e.g., no change to the values of the non-conjoint MVs). In some embodiments, the low and high control bounds (e.g., CV_Lo and CV_Hi) in the secondary controller 160 is representative and/or indicative of the tolerance provided by the conjoint secondary controller MVs. Said differently, in some embodiments, the low and high control bounds (e.g., CV_Lo and CV_Hi) in the secondary controller 160 is representative and/or indicative of a maximum amount by which the master controller 140 may move/adjust the current value of a secondary controller CV constraint (or corresponding conjoint MVs) during an optimization iteration while honoring the constraints imposed by the secondary controller. The high and low control bounds (e.g., CV_Lo and CV_Hi), for example, may be indicative of a difference between the current value for a secondary controller CV constraint and its high limit or low limit.

In some embodiments, the master controller 140 and/or the secondary controller 160 leverages the non-conjoint MVs to relax the control bounds of the secondary controller CV constraint within the master controller 140 when represented in the master controller model 300A. For example, the master controller 140 and/or the secondary controller 160 may leverage the non-conjoint MVs (e.g., second portion 508) to provide more room for the primary optimizer (e.g., embedded optimizer of the master controller 140) to optimize in order to achieve the optimal operating point 436 while staying within the feasible operating region 422 and avoiding constraint violations. Said differently, in some embodiments, the master controller 140 and/or the secondary controller 160 may move/adjust the value of one or more non-conjoint secondary controller MVs, thus providing more room for optimization. Otherwise, the primary optimizer may be limited to the tolerance provided by conjoint secondary controller MVs which may not be adequate in some cases. In this regard, in some embodiments, the master controller 140 and/or the secondary controller 160 leverages the non-conjoint MVs (e.g. second portion 508 of the respective model row) to relax the co-control bounds (e.g., CoCV_Lo and CoCV_{Hi}) of the secondary controller CV constraint incorporated into the master controller model 300A by moving/adjusting the non-conjoint MVs (e.g., adjusting the values of one or more non-conjoint MVs).

In some embodiments, by using a tuning parameter that is greater than 0 and less than 1, the master controller 140 and/or the secondary controller 160 leverages only a portion of the maximum tolerance/range provided by the non-conjoint MVs at each optimization iteration to, for example, avoid a situation where the secondary controller 160 may not be able to adjust quickly and/or avoid pushing the secondary controller 160 too hard. In some embodiments, the maximum tolerance/range provided by the non-conjoint MVs comprises an amount by which the master controller 140 may move/adjust the secondary controller MVs without constraint violations.

By way of example, if the secondary controller CV constraint corresponds to a furnace temperature and tolerance provided by the secondary controller CV constraints, or otherwise the conjoint secondary controller MVs, is 2 degrees from the high limit, the master controller 140 and/or the secondary controller 160 may move/adjust the furnace temperature up by no more than 2 degrees if the non-conjoint MVs are not leveraged. By moving/adjusting a non-conjoint secondary controller MV such as quench and/or cooling air, the co-control bounds (e.g., CoCV_Lo and CoCV_{Hi}) are relaxed in that the quench and/or cooling air may cause the furnace temperature to reduce/drop, thus allowing for the master controller 140 to push the secondary controller without violation. For example, the master controller 140 may cause the secondary controller to direct the furnace to produce more output without the furnace temperature exceeding its high limit. By way of example, in some implementations where the tuning parameter is 0.5 and the maximum assistive control range provided by the non-conjoint MVs is 10 degrees for the furnace temperature, a first optimization iteration may have a maximum of 5 degrees range (e.g., 0.5*10 degrees). For example, applying 2 degrees of the 5 degrees may cause the furnace temperature to drop by 2 degrees, thus relaxing the co-control bounds.

As described above, in some embodiments, the master controller 140 and/or the secondary controller 160 may be configured to perform one or more optimization iterations. Each optimization iteration may move the predicted optimal operating point 438 closer to the optimal operating point 436. For example, the predicted optimal operating point 438 may move towards the optimal operating point 436 with each optimization iteration. As shown in FIG. 5, by augmenting the master controller model 300A to include the set of secondary controller CV constraints, the estimated feasible operating region 426 is such that the predicted optimal operating point 438 is within the feasible operating region 422.

In this regard, in some embodiments, the master controller 140 and/or the secondary controller 160 may achieve and maintain the optimal operating point 436 based on performance of one or more optimization iterations using a master controller model 300A that is augmented with one or more secondary controller MV constraints. In this regard, in some embodiments, to achieve and maintain an optimal operating point 436, a co-control technique is leveraged, as described above. The co-control technique, as described above, comprises using the set of master controller MVs (e.g., conjoint master controller MVs) of the master controller 140 and set of non-conjoint MVs of the secondary controller 160. For example, if the feasible operating region 422 is not accurately estimated (e.g., if the estimated feasible operating region 426 is not accurate) and/or the set of master controller MVs (e.g., master controller conjoint MV(s) of the master controller 140) is not properly coordinated with the set of secondary controller non-conjoint MVs, the control performance of a secondary controlled controller variable (e.g., such as CV3 in FIG. 4) may suffer. Additionally, the predicted optimal operating point 438 may be artificially restricted away significantly from the optimal operating point 436.

In some embodiments, the set of co-control criteria and/or co-control technique may be applied to dynamic constraints and/or steady-state constraints. By way of example, steady state co-control may be employed when the master controller model comprises slower dynamics than the one or more secondary controllers 160. In this regard, the last model row of the corresponding secondary controller step-response dynamic matrix may be incorporated (e.g., augmented, appended, represented, or similar terms) within the master controller. By way of another example, in scenarios where the master controller and the secondary controller have similar response times, more model rows from the secondary controller model (e.g., starting from the bottom row) may be incorporated into the master controller 140.

In some embodiments, the master controller 140 and/or the secondary controller 160 is configured to enable performance of one or more plant optimization actions. In some embodiments, the master controller 140 and/or the secondary controller 160 is configured to enable performance of one or more plant optimization actions based on the estimated feasible operating region 426. In this regard, in some embodiments, the master controller 140 and/or the secondary controller 160 is configured to enable performance of one or more plant optimization actions in order to optimize the plant 102, individual physical processing units of the plant 102, individual physical storage units of the plant 102, individual physical streams of the plant 102 while managing to respect the constraints of the secondary controller 160, such as by ensuring any plant optimization actions do not cause the operating point 434 to be adjusted such that the operating point 434 is outside of the feasible operating region 422. In some embodiments, enabling the master controller to perform the one or more plant optimization actions causes a reduction in a distance between the operating point 434 (or predicted optimal operating point 438) and the optimal operating point 436. In this regard, for example, enabling performance of one or more plant optimization actions may optimize operation of the plant 102 (e.g., by moving the operating point 434 (or predicted optimal operating point 438) closer to the optimal operating point 436) while ensuring that various constraints of the secondary controller 160 are not violated.

In some embodiments, enabling performance of one or more plant optimization actions may comprise the master controller 140 and/or the secondary controller 160 being configured to generate an adjustment feature for a non-conjoint secondary controller MV from the set of non-conjoint MVs in order to leverage the non-conjoint secondary controller MV, as discussed above. Alternatively, or additionally, in some embodiments, enabling performance of one or more plant optimization actions may comprise the master controller 140 and/or the secondary controller 160 being configured to generate an adjustment feature for a conjoint secondary controller MV from the set of conjoint secondary controller MV associated with the first secondary controller variable.

In some embodiments, an adjustment feature comprises one or more items of data representative and/or indicative of an amount that a particular master variable (e.g., master controller MV, conjoint secondary controller MV, non-conjoint secondary controller MV, and/or the like) should be adjusted in order to optimize the plant 102, individual physical processing units of the plant 102, individual physical storage units of the plant 102, individual physical streams of the plant 102 while managing to respect the constraints of the secondary controller 160. For example, an adjustment feature may comprise one or more items of data representative and/or indicative of an amount that a master controller MV, conjoint secondary controller MV, or non-conjoint secondary controller MV should be adjusted in order to cause the distance/difference between the operating point 434 (or predicted optimal operating point 438) and the optimal operating point 436 to be reduced.

In some embodiments, enabling performance of one or more plant optimization actions comprises the master controller 140 and/or the secondary controller 160 being configured to actuate a physical processing unit of the plant 102 (e.g., by causing the physical processing unit of the plant 102 to operate, such as by transmitting a signal to the physical processing unit of the plant 102 and/or a computing device associated with the physical processing unit). For example, enabling performance of one or more plant optimization actions may comprise the master controller 140 and/or the secondary controller 160 being configured to actuate a hydrocracking physical processing unit of the plant 102, such as to increase an output of the hydrocracking physical processing unit of the plant 102. Additionally, or alternatively, enabling performance of one or more plant optimization actions comprises the master controller 140 and/or the secondary controller 160 being configured to actuate a physical stream of the plant 102 (e.g., by causing the physical stream of the plant 102 to operate, such as by transmitting a signal to the physical stream of the plant 102 and/or a computing device associated with the physical stream). For example, enabling performance of one or more plant optimization actions may comprise the master controller 140 and/or the secondary controller 160 being configured to actuate an input feed into a hydrocracking physical processing unit of the plant 102, such as to increase input feed into the hydrocracking physical processing unit of the plant 102. In this regard, in some embodiments, actuating at least one of physical processing unit of the plant or physical stream of the plant causes a flow rate in at least one physical stream of the plant to increase or decrease (e.g., an increase and/or decrease in the flow rate of a feed). In some embodiments, actuating a physical processing unit of the plant 102 and/or a physical stream of the plant 102 causes the movement distance between the operating point 434 and the optimal operating point 436 to be reduced.

### Example Methods

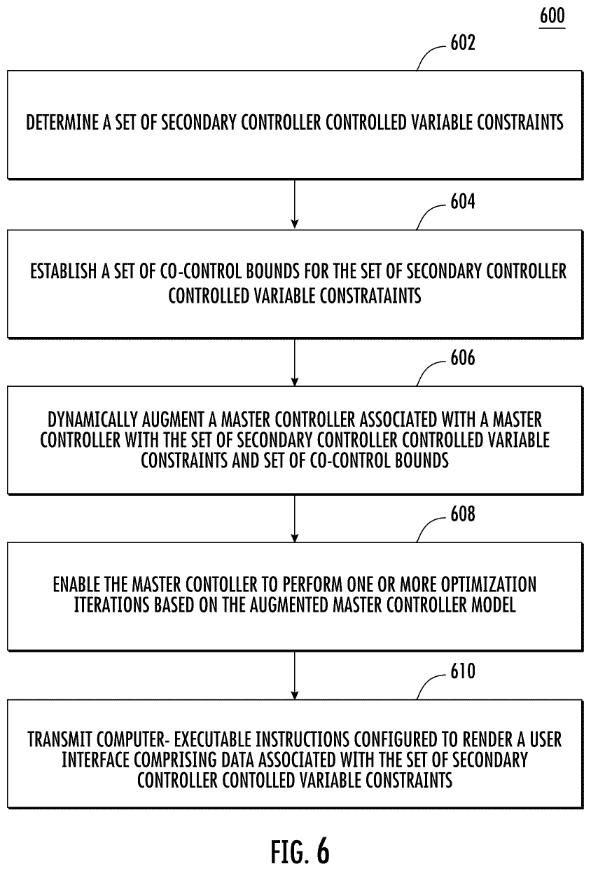

Referring now to FIG. 6, a flowchart providing an example method 600 is illustrated. In this regard, FIG. 6 illustrates operations that may be performed by the system, master controller 140, the secondary controller 160, the user device 170, the plant 102, and/or the like. In some embodiments, the method 600 includes operations for co-control techniques for plantwide optimization in accordance with at least some embodiments of the present disclosure. In some embodiments, the example method 600 defines a computer-implemented process, which may be executable by any of the device(s) and/or system(s) embodied in hardware, software, firmware, and/or a combination thereof, as described herein. In some embodiments, computer program code including one or more computer-coded instructions are stored to at least one non-transitory computer-readable storage medium, such that execution of the computer program code initiates performance of the method 600.

As shown in block 602, the method 600 may comprise selecting a set of secondary controller CV constraints. In some embodiments, selecting the set of secondary controller CV constraints comprises determining, based on a set of co-control criteria, a set of secondary controller CV constraints that satisfy the set of co-control criteria. In this regard, in some embodiments, the set of secondary controller CV constraints comprises one or more constraints associated with a first secondary controller CV, of one or more secondary controller CVs, that satisfies the set of co-control criteria. In some embodiments the set of secondary controller CV constraints is associated with a set of control bounds. In some embodiments, a plurality of sets of secondary controller CV constraints is selected, wherein each set of secondary controller CV constraint is associated with a unique secondary controller CV (e.g., second secondary controller CV, third secondary controller CV, and/or the like) and comprises one or more constraints associated with the respective secondary controller CV.

In some embodiments, the set of secondary controller CV constraints corresponds to a set of conjoint secondary controller MVs associated with the first secondary controller CV. In some embodiments, a first secondary controller MV of the set of conjoint secondary controller MVs is a conjoint MV with a first master controller MV of a set of master controller MVs associated with the master controller. In some embodiments, a second secondary controller MV of the set of conjoint secondary controller MVs is a conjoint MV with a second master controller MV of the set of master controller MVs associated with the master controller.

In some embodiments, determining the set of secondary controller CV constraints comprises determining the set of secondary controller CV constraints satisfy at least one co-control criteria from the set of co-control criteria. In some embodiments, the set of co-control criteria comprises one or more of: (i) a secondary controller CV constraint predicted to be violated by a current predicted optimal operating point, (ii) a secondary controller CV constraint predicted to be within a threshold distance from a set of control bounds associated with the secondary controller CV constraint within a predefined tolerance, or (iii) a secondary controller CV constraint that currently violates a set of control limits for the secondary controller CV constraint.

In some embodiments the first secondary controller CV is associated with a feasible operating region defined at least in part by the set of secondary controller CV constraints. In some embodiments, an optimal operating point is within the feasible operating region. In some embodiments, the feasible operating region is further defined at least in part by another set of secondary controller CV constraints associated with a second secondary controller CV. The first secondary controller CV and the second secondary controller variable are associated with same secondary controller model associated with a secondary controller. In some embodiments, the master controller is cascaded on top of the secondary controller. In some embodiments, the augmented master controller model further comprises the another set of secondary controller CV constraints.

As shown in block 604, the method 600 may comprise establishing a set of co-control bounds for the set of secondary controller CV constraints based on (i) a set of non-conjoint MVs associated with the first secondary controller CV and (ii) a tuning parameter. In some embodiments, the tuning parameter is configurable. In some embodiments, the tuning parameter is between a range of 0 to 1.

In some embodiments, establishing the set of co-control bounds for the set of secondary controller CV constraints based on the set of non-conjoint MVs is configured to cause the set of control bounds of the set of secondary controller CV constraints to be relaxed within the master controller. For example, the set of co-control bounds of the set of secondary controller CV constraints may comprise the set of control bounds of the set of secondary controller CV constraints that is relaxed within the master controller using the set of non-conjoint MVs.

As shown in block 606, the method 600 may comprise dynamically augmenting a master controller model associated with a master controller with the set of secondary controller CV constraints and the set of co-control bounds, to generate an augmented master controller model.

As shown in block 608, the method 600 may comprise enabling the master controller to perform one or more optimization iterations based on the augmented master controller model and using an optimizer associated with the master controller. In some embodiments, enabling the master controller to perform the one or more optimization iterations causes a reduction in distance between (i) a current predicted operating point and (ii) the optimal operating point. In some embodiments, a first optimization iteration of the one or more optimization iterations causes a current predicted optimal operating point to be within the feasible operating region. The current predicted optimal operating point may be predicted using the master controller. In some embodiments, a second optimization iteration of the one or more optimization iterations causes the current predicted optimal operating point to move towards the optimal operating point.

In some embodiments, enabling the master controller to perform one or more optimization iterations may comprise enabling the master controller to perform one or more plant optimization actions. In some embodiments, the one or more plant optimization actions may comprise actuating at least one of a physical processing unit of a plant or a physical stream of the plant. As described above, in some embodiments, the master controller 140 and/or the secondary controller 160 is configured to enable performance of one or more plant optimization actions in order to optimize the plant 102, individual physical processing units of the plant 102, individual physical storage units of the plant 102, individual physical streams of the plant 102 while managing to respect the constraints of the secondary controller 160, such as by ensuring any plant optimization actions do not cause the operating point 434 to be adjusted such that the operating point 434 or the predicted optimal operating point 438 is outside of the feasible operating region 422. In some embodiments, enabling performance of one or more plant optimization actions comprises the master controller 140 and/or the secondary controller 160 being configured to actuate a physical processing unit of the plant 102 (e.g., by causing the physical processing unit of the plant 102 to operate, such as by transmitting a signal to the physical processing unit of the plant 102 and/or a computing device associated with the physical processing unit). For example, enabling performance of one or more plant optimization actions may comprise the master controller 140 and/or the secondary controller 160 being configured to actuate a hydrocracking physical processing unit of the plant 102, such as to increase an output of the hydrocracking physical processing unit of the plant 102. Additionally, or alternatively, enabling performance of one or more plant optimization actions comprises the master controller 140 and/or the secondary controller 160 being configured to actuate a physical stream of the plant 102 (e.g., by causing the physical stream of the plant 102 to operate, such as by transmitting a signal to the physical stream of the plant 102 and/or a computing device associated with the physical stream). For example, enabling performance of one or more plant optimization actions may comprise the master controller 140 and/or the secondary controller 160 being configured to actuate an input feed into a hydrocracking physical processing unit of the plant 102, such as to increase input feed into the hydrocracking physical processing unit of the plant 102. In this regard, in some embodiments, actuating at least one of physical processing unit of the plant or physical stream of the plant causes a flow rate in at least one physical stream of the plant to increase or decrease (e.g., an increase and/or decrease in the flow rate of a feed).

In some embodiments, enabling performance of one or more plant optimization actions may comprise the master controller 140 and/or the secondary controller 160 being configured to generate an adjustment feature for a non-conjoint secondary controller MV from the set of non-conjoint MVs in order to leverage the non-conjoint secondary controller MV, as discussed above. Alternatively, or additionally, in some embodiments, enabling performance of one or more plant optimization actions may comprise the master controller 140 and/or the secondary controller 160 being configured to generate an adjustment feature for a conjoint secondary controller MV from the set of conjoint secondary controller MV associated with the first secondary controller variable.

In some embodiments, an adjustment feature comprises one or more items of data representative and/or indicative of an amount that a particular master variable (e.g., master controller MV, conjoint secondary controller MV, non-conjoint secondary controller MV, and/or the like) should be adjusted in order to optimize the plant 102, individual physical processing units of the plant 102, individual physical storage units of the plant 102, individual physical streams of the plant 102 while managing to respect the constraints of the secondary controller 160. For example, an adjustment feature may comprise one or more items of data representative and/or indicative of an amount that a master controller MV, conjoint secondary controller MV, or non-conjoint secondary controller MV should be adjusted in order to cause the distance/difference between the operating point 434 (or predicted optimal operating point 438) and the optimal operating point 436 to be reduced.

As shown in block 610, the method 600 may comprise transmitting one or more computer-executable instructions configured to cause rendering of a user interface on a client computing device, wherein the user interface comprises data associated with the first secondary controller CV and/or other secondary controller CVs incorporated within the master controller model.

In some embodiments, the method may comprise detecting conflict between the first secondary controller CV and a master controller CV associated with the master controller, and resolving the conflict. In some examples, where protecting the secondary controller variables (e.g., for safety or operations purpose) is more important (e.g., higher priority) relative to protecting the master controller CV constraints, the conflict may be resolved by increasing the tuning parameter (e.g., increase the co-control factor), so as to enlist the set of non-conjoint MVs to mitigate the errors associated with the set of appended/augmented secondary controller CVs, increasing the secondary controller controlled weight factor (e.g., CV weight factor), or increasing the secondary controller CV priority. In this regard, in some embodiments, the conflict may be resolved by one or more of (i) increasing the tuning parameter (ii) increasing a weight associated with the first secondary controller CV, or (iii) increasing a priority associated with the first secondary controller CV.

In some examples, where protecting the master controller CV constraints (e.g., PWO primary CV constraints) is more important relative to protecting the secondary controller CV constraints, the conflict may be resolved by decreasing the tuning parameter (e.g., decrease the co-control factor), decreasing the secondary controller controlled weight factor (e.g., CV weight factor), or decreasing the secondary controller CV priority. In this regard, in some embodiments, the conflict may be resolved by one or more of (i) decreasing the tuning parameter, (ii) decreasing a weight associated with the first secondary controller CV, or (iii) decreasing a priority associated with the first secondary controller CV.

### CONCLUSION

Although an example processing system has been described above, implementations of the subject matter and the functional operations described herein can be implemented in other types of digital electronic circuitry, or in computer software, firmware, or hardware, including the structures disclosed in this specification and their structural equivalents, or in combinations of one or more of them.

Embodiments of the subject matter and the operations described herein can be implemented in digital electronic circuitry, or in computer software, firmware, or hardware, including the structures disclosed in this specification and their structural equivalents, or in combinations of one or more of them. Embodiments of the subject matter described herein can be implemented as one or more computer programs, i.e., one or more modules of computer program instructions, encoded on computer storage medium for execution by, or to control the operation of, information/data processing apparatus. Alternatively, or in addition, the program instructions can be encoded on an artificially-generated propagated signal, e.g., a machine-generated electrical, optical, or electromagnetic signal, which is generated to encode information/data for transmission to suitable receiver apparatus for execution by an information/data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described herein can be implemented as operations performed by an information/data processing apparatus on information/data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a repository management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or information/data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described herein can be performed by one or more programmable processors executing one or more computer programs to perform actions by operating on input information/data and generating output. Processors suitable for the execution of a computer program include, by way of example, both general and special purpose microprocessors, and any one or more processors of any kind of digital computer. Generally, a processor will receive instructions and information/data from a read-only memory or a random access memory or both. The essential elements of a computer are a processor for performing actions in accordance with instructions and one or more memory devices for storing instructions and data. Generally, a computer will also include, or be operatively coupled to receive information/data from or transfer information/data to, or both, one or more mass storage devices for storing data, e.g., magnetic, magneto-optical disks, or optical disks. However, a computer need not have such devices. Devices suitable for storing computer program instructions and information/data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described herein can be implemented on a computer having a display device, e.g., a CRT (cathode ray tube) or LCD (liquid crystal display) monitor, for displaying information/data to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described herein can be implemented in a computing system that includes a back-end component, e.g., as an information/data server, or that includes a middleware component, e.g., an application server, or that includes a front-end component, e.g., a client computer having a graphical user interface or a web browser through which a user can interact with an implementation of the subject matter described herein, or any combination of one or more such back-end, middleware, or front-end components. The components of the system can be interconnected by any form or medium of digital information/data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits information/data (e.g., an HTML page) to a client device (e.g., for purposes of displaying information/data to and receiving user input from a user interacting with the client device). Information/data generated at the client device (e.g., a result of the user interaction) can be received from the client device at the server.

While this specification contains many specific implementation details, these should not be construed as limitations on the scope of any disclosures or of what may be claimed, but rather as descriptions of features specific to particular embodiments of particular disclosures. Certain features that are described herein in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A computer-implemented method comprising:
determining, based on a set of co-control criteria, a set of secondary controller CV constraints, wherein the set of secondary controller CV constraints comprises one or more constraints associated with a first secondary controller CV that satisfies the set of co-control criteria, and wherein the set of secondary controller CV constraints is associated with a set of control bounds;
establishing a set of co-control bounds for the set of secondary controller CV constraints based on (i) a set of non-conjoint MVs associated with the first secondary controller CV and (ii) a tuning parameter;
dynamically augmenting a master controller model associated with a master controller with the set of secondary controller CV constraints and the set of co-control bounds to generate an augmented master controller model; and
enabling the master controller to perform one or more optimization iterations based on the augmented master controller model.

2. The computer-implemented method of claim 1, wherein the set of secondary controller CV constraints corresponds to a set of conjoint secondary controller MVs associated with the first secondary controller CV.

3. The computer-implemented method of claim 2, wherein a first secondary controller MV of the set of conjoint secondary controller MVs is a conjoint MV with a first master controller MV of a set of master controller MVs associated with the master controller, and wherein a second secondary controller MV of the set of conjoint secondary controller MVs is a conjoint MV with a second master controller MV of the set of master controller MVs associated with the master controller.

4. The computer-implemented method of claim 1, wherein determining the set of secondary controller CV constraints comprises determining the set of secondary controller CV constraints satisfy at least one co-control criteria from the set of co-control criteria.

5. The computer-implemented method of claim 1, wherein the set of co-control criteria comprises one or more of: (i) a secondary controller CV constraint predicted to be violated by a current predicted optimal operating point, (ii) a secondary controller CV constraint predicted to be within a threshold distance from a set of control bounds associated with the secondary controller CV constraint within a predefined tolerance; or (iii) a secondary controller CV constraint that currently violates a set of control limits for the secondary controller CV constraint.

6. The computer-implemented method of claim 1, wherein the first secondary controller CV is associated with a feasible operating region defined at least in part by the set of secondary controller CV constraints, wherein an optimal operating point is within the feasible operating region.

7. The computer-implemented method of claim 6, wherein the feasible operating region is further defined at least in part by another set of secondary controller CV constraints associated with a second secondary controller CV, wherein the first secondary controller CV and the second secondary controller CV are associated with same secondary controller model, wherein the augmented master controller model further comprises the another set of secondary controller CV constraints.

8. The computer-implemented method of claim 6, wherein enabling the master controller to perform the one or more optimization iterations causes a reduction in distance between (i) a current predicted operating point and (ii) the optimal operating point.

9. The computer-implemented method of claim 6, wherein a first optimization iteration of the one or more optimization iterations causes a current predicted optimal operating point to be within the feasible operating region.

10. The computer-implemented method of claim 9, wherein a second optimization iteration of the one or more optimization iterations causes the current predicted optimal operating point to move towards the optimal operating point.

11. The computer-implemented method of claim 1, wherein the tuning parameter is configurable and is between a range of 0 to 1.

12. The computer-implemented method of claim 1, wherein establishing the set of co-control bounds for the set of secondary controller CV constraints based on the set of non-conjoint MVs is configured to cause the set of control bounds of the set of secondary controller CV constraints to be relaxed within the master controller.

13. The computer-implemented method of claim 1, further comprising:
detecting conflict between the first secondary controller CV and a master controller CV associated with the master controller; and
resolving the conflict by one or more of (i) increasing the tuning parameter or (ii) increasing a weight associated with the first secondary controller CV.

14. The computer-implemented method of claim 1, further comprising:
detecting conflict between the first secondary controller CV and a master controller CV associated with the master controller; and
resolving the conflict by one or more of (i) decreasing the tuning parameter or (ii) decreasing a weight associated with the first secondary controller CV.

15. The computer-implemented method of claim 1, further comprising transmitting one or more computer-executable instructions configured to cause rendering of a user interface on a client computing device, wherein the user interface comprises data associated with the first secondary controller CV.

16. An apparatus comprising at least one processor and at least one memory storing instructions that, when executed by the at least one processor, cause the apparatus to:
determine, based on a set of co-control criteria, a set of secondary controller CV constraints, wherein the set of secondary controller CV constraints comprises one or more constraints associated with a first secondary controller CV that satisfies the set of co-control criteria, and wherein the set of secondary controller CV constraints is associated with a set of control bounds;
establish a set of co-control bounds for the set of secondary controller CV constraints based on (i) a set of non-conjoint MVs associated with the first secondary controller CV and (ii) a tuning parameter;
dynamically augment a master controller model associated with a master controller with the set of secondary controller CV constraints and the set of co-control bounds to generate an augmented master controller model; and
enable the master controller to perform one or more optimization iterations based on the augmented master controller model and using an optimizer associated with the master controller.

17. The apparatus of claim 16, wherein the set of secondary controller CV constraints corresponds to a set of conjoint secondary controller MVs associated with the first secondary controller CV.

18. The apparatus of claim 17, wherein a first secondary controller MV of the set of conjoint secondary controller MVs is a conjoint MV with a first master controller MV of a set of master controller MVs associated with the master controller, and wherein a second secondary controller MV of the set of conjoint secondary controller MVs is a conjoint MV with a second master controller MV of the set of master controller MVs associated with the master controller.

19. The apparatus of claim 17, wherein determining the set of secondary controller CV constraints comprises determining the set of secondary controller CV constraints satisfy at least one co-control criteria from the set of co-control criteria.

20. At least one non-transitory computer-readable storage medium, the at least one non-transitory computer-readable storage medium having computer coded instructions configured to, when executed by at least one processor:
determine, based on a set of co-control criteria, a set of secondary controller CV constraints, wherein the set of secondary controller CV constraints comprises one or more constraints associated with a first secondary controller CV that satisfies the set of co-control criteria, and wherein the set of secondary controller CV constraints is associated with a set of control bounds;
establish a set of co-control bounds for the set of secondary controller CV constraints based on (i) a set of non-conjoint MVs associated with the first secondary controller CV and (ii) a tuning parameter;
dynamically augment a master controller model associated with a master controller with the set of secondary controller CV constraints and the set of co-control bounds to generate an augmented master controller model; and
enable the master controller to perform one or more optimization iterations based on the augmented master controller model and using an optimizer associated with the master controller.
